(19) United States
(12) Patent Application Publication
(10) Pub. No.: US 2025/0229597 A1
(43) Pub. Date: Jul. 17, 2025

(54) VEHICLE BEAM

(71) Applicant: TOYODA GOSEI CO., LTD., Kiyosu-shi (JP)

(72) Inventors: Hiroki TAKAI, Aichi-ken (JP); Daisuke NAGANO, Aichi-ken (JP); Tetsuya KAWAMURA, Aichi-ken (JP); Shuji KANAMOTO, Aichi-ken (JP)

(21) Appl. No.: 19/014,570

(22) Filed: Jan. 9, 2025

(30) Foreign Application Priority Data
Jan. 12, 2024 (JP) 2024-003042
Sep. 27, 2024 (JP) 2024-169138

(51) Int. Cl. B60H 1/00; B60H 1/24; B62D 25/14

(52) U.S. Cl. CPC B60H 1/00564; B60H 1/0055; B60H 1/242; B62D 25/142

(57) ABSTRACT

A vehicle beam extends in a vehicle width direction within an instrument panel of a vehicle to support the instrument panel. The vehicle beam includes a tubular duct body portion, a peripheral portion connected to the duct body portion, and a beam shell portion made of a resin material. The beam shell portion is divided into a plurality of beam divided bodies in a circumferential direction of the beam shell portion. Each of the beam divided bodies has a beam connection portion at a boundary with an adjacent beam divided body. The adjacent beam divided bodies are coupled by joining the adjacent beam connection portions. The adjacent beam connection portions have a pair of beam facing surfaces. One of the beam facing surfaces is formed with a beam welding rib extending along the beam facing surface. The adjacent beam connection portions are joined by welding at the beam welding rib.

### CROSS-REFERENCE TO RELATED APPLICATIONS

This application is based on and claims priority under 35 USC 119 from Japanese Patent Applications No. 2024-003042 filed on Jan. 12, 2024 and No. 2024-169138 filed on Sep. 27, 2024, the entire content of which is incorporated herein by reference.

### TECHNICAL FIELD

The present disclosure relates to a vehicle beam.

### BACKGROUND ART

As one form of a vehicle beam that supports an instrument panel of a vehicle, the vehicle beam having a function of a duct through which air sent from an air conditioning system flows is described in, for example, JP2004-345396A.

A framework of the vehicle beam is formed of a hollow duct body portion having a tubular shape and an air flow path. A shell of the vehicle beam is constituted by a beam shell portion formed in a tubular shape and made of a resin material. The beam shell portion is divided into a plurality of beam divided bodies in a circumferential direction of the beam shell portion. In each beam divided body, a beam connection portion is formed at a boundary with an adjacent beam divided body. Adjacent beam connection portions are fastened together by a plurality of bolts. The adjacent beam connection portions are joined by the fastening described above, thereby coupling the adjacent beam divided bodies. The above-mentioned coupling is performed for all the beam divided bodies to form the beam shell portion.

In the vehicle beam described in JP2004-345396A, the adjacent beam connection portions are joined together by being fastened with a plurality of bolts disposed at regular intervals. Therefore, a fastening force of the bolt becomes weaker as a distance from the bolt increases. Accordingly, the sealing performance of a joint portion decreases as the distance from the bolt increases. Therefore, it is required to improve the vehicle beam described in JP2004-345396A in terms of improving the sealing performance of the joint portion.

### SUMMARY OF INVENTION

An aspect of the present disclosure will be described.

(1) The aspect of the present disclosure provides a vehicle beam that extends in a vehicle width direction within an instrument panel of a vehicle and is attached to a vehicle body to support the instrument panel, the vehicle beam including:
as a framework of the vehicle beam, a tubular duct body portion having a tubular shape and a flow path for air;
a peripheral portion connected to the duct body portion; and
as a shell of the vehicle beam, a beam shell portion formed in a tubular shape and made of a resin material,
in which the beam shell portion is divided into a plurality of beam divided bodies in a circumferential direction of the beam shell portion,
each of the beam divided bodies has a beam connection portion at a boundary with an adjacent beam divided body,
the beam divided bodies adjacent to each other are coupled by joining the beam connection portions adjacent to each other,
the beam connection portions adjacent to each other have a pair of beam facing surfaces that face each other,
at least one of the pair of beam facing surfaces is formed with a beam welding rib extending along the pair of beam facing surfaces in a direction intersecting a direction in which the pair of beam facing surfaces face each other, and
the beam connection portions adjacent to each other are joined together by welding the adjacent beam connection portions at the beam welding rib.

According to the above configuration, the adjacent beam divided bodies are coupled by joining the adjacent beam connection portions together. The above-mentioned coupling is performed for all the beam divided bodies to form the beam shell portion. The joining is performed by welding the adjacent beam connection portions at the beam welding rib. The beam welding rib extends along the beam facing surface of at least one of the adjacent beam connection portions in the direction intersecting the facing direction in which the pair of beam facing surfaces of the adjacent beam connection portions face each other. Accordingly, the adjacent beam connection portions are joined in a wider region in the intersecting direction than a case of bolt fastening. The sealing performance of the joint portion between the adjacent beam connection portions is improved as compared with the case of bolt fastening.

(2) In the vehicle beam of the aspect, the duct body portion is made of a resin material,
the duct body portion is divided into a plurality of duct divided bodies in a circumferential direction of the duct body portion,
the plurality of beam divided bodies of the beam shell portion are formed by the plurality of duct divided bodies of the duct body portion,
each of the duct divided bodies has, as the beam connection portion, a duct connection portion at a boundary portion with an adjacent duct divided body,
the duct connection portions adjacent to each other have a pair of duct facing surfaces facing each other and forming the beam facing surfaces,
at least one of the pair of duct facing surfaces is formed with, as the beam welding rib, a duct welding rib extending along the pair of duct facing surfaces in a direction intersecting a facing direction in which the pair of duct facing surfaces face each other,
the duct connection portions adjacent to each other are joined together by welding at the duct welding rib, and
due to the joining of the adjacent duct connection portions, the duct divided bodies adjacent to each other are coupled, and the beam divided bodies adjacent to each other are coupled.

According to the above configuration, the plurality of duct divided bodies of the duct body portion form the plurality of beam divided bodies of the beam shell portion. The duct connection portion having the duct facing surface forms the beam connection portion having the beam facing surface. The duct welding rib forms the beam welding rib.

When the duct connection portions adjacent to each other are welded at the duct welding rib, the duct connection portions adjacent to each other are joined together. Further, the beam connection portions adjacent to each other are welded at the beam welding rib, and the beam connection portions adjacent to each other are joined together.

The adjacent duct divided bodies are coupled by the joining described above, and therefore the adjacent beam divided bodies are coupled. By performing the coupling for all the duct divided bodies, the coupling is performed for all the beam divided bodies. By the coupling, the duct body portion is formed and the beam shell portion is formed.

In the duct body portion formed as described above, the duct connection portions adjacent to each other are joined in a wider region in the direction intersecting the facing direction than in the case of bolt fastening. The sealing performance of the joint portion between the adjacent duct connection portions is improved as compared with the case of bolt fastening. In addition, due to the improvement of the sealing performance, the phenomenon in which air flowing through the flow path leaks out from the joint portion is reduced more than in the case of bolt fastening.

Further, in the beam shell portion formed as described above, the beam connection portions adjacent to each other are joined in a wider region in the direction intersecting the facing direction than in the case of bolt fastening. The sealing performance of the joint portion between the adjacent beam connection portions is improved as compared with the case of bolt fastening.

(3) In the vehicle beam of the aspect, the duct welding rib is formed on each of the pair of duct facing surfaces of the adjacent duct connection portions,
the duct welding rib formed on one of the duct facing surfaces and the duct welding rib formed on an other one of the duct facing surfaces face each other in the facing direction,
the adjacent duct connection portions are joined together by welding a pair of the duct welding ribs that face each other in the facing direction, and
the duct divided bodies adjacent to each other are coupled due to the joining of the adjacent duct connection portions.

According to the above configuration, when the duct welding rib is formed on only one of a pair of duct facing surfaces of the adjacent duct connection portions, the duct welding rib is welded to the duct connection portion on the other duct facing surface. During welding of the duct welding rib, the temperature of a tip end surface of the duct welding rib is raised. On the other hand, during welding of the duct connection portion having the other duct facing surface, the temperature of a location facing the duct welding rib and a peripheral portion thereof in the duct facing surface is raised. An area of the duct facing surface that needs to be heated up is larger than the tip end surface of the duct welding rib. Therefore, heat is more likely to dissipate, and the efficiency of temperature rise is decreased.

In this regard, according to the above configuration in which the duct welding ribs formed on the one duct facing surface and the duct welding ribs formed on the other duct facing surface face each other in the facing direction, the duct welding ribs are welded together. In each duct welding rib, the temperature of the tip end surface is raised during welding. An area of the tip end surface of each duct welding rib that needs to be heated up is smaller than the area of the location of the duct facing surface that needs to be heated up. Therefore, heat is less likely to dissipate, and the efficiency of temperature rise is increased.

(4) In the vehicle beam of the aspect, each of the duct divided bodies has the duct connection portion on each of both end portions of the duct body portion in the
circumferential direction, and the duct facing surface of the duct connection portion on a one end portion and the duct facing surface of the duct connection portion on an other end portion face different directions.

According to the above configuration, the duct body portion is formed by coupling adjacent duct divided bodies to each other for all the duct divided bodies. The coupling is achieved by joining the adjacent duct connection portions together. The joining is achieved by welding the duct welding ribs of the adjacent duct connection portions.

At the time of the joining, before the welding, for all the duct divided bodies, adjacent duct divided bodies are brought close to each other, and the duct welding ribs at the adjacent duct connection portions are brought close to each other.

Here, for each of the duct divided bodies, if the duct facing surface of the duct connection portion at the one end portion of the two end portions in the circumferential direction of the duct body portion and the duct facing surface of the duct connection portion at the other end portion face the same direction, the following phenomenon may occur. That is, two duct welding ribs are brought close to each other in a state where the duct welding ribs of the adjacent duct connection portions do not face each other, that is, in a state where the duct welding ribs are misaligned in a direction along the duct facing surface.

In this regard, according to the above configuration, for each of the duct divided bodies, the duct facing surface of the duct connection portion at the one end portion and the duct facing surface of the duct connection portion at the other end portion face in different directions.

Therefore, when the adjacent duct divided bodies approach each other and the duct welding ribs of adjacent duct connection portions approach each other before the welding, the duct welding rib of the duct connection portion at the one end portion and the duct welding rib of the duct connection portion adjacent thereto come into contact with each other. By this contact, the adjacent duct divided bodies are positioned in the direction in which the duct facing surfaces of the duct connection portions face each other. Accordingly, for the adjacent duct divided bodies, the duct welding rib of the duct connection portion at the other end portion and the duct welding rib of the duct connection portion adjacent thereto are positioned in the above-described direction. With this positioning, the two duct welding ribs can be brought close to each other and welded together in a state where the duct welding rib of the duct connection portion at the other end portion and the duct welding rib of the duct connection portion adjacent thereto are made to face each other. Then, welding in the positioned state is performed on all the duct divided bodies.

In the same manner as described above, when the adjacent duct divided bodies approach each other and the duct welding ribs of adjacent duct connection portions approach each other before the welding, the duct welding rib of the duct connection portion at the other end portion and the duct welding rib of the duct connection portion adjacent thereto come into contact with each other. By this contact, the adjacent duct divided bodies are positioned in the direction in which the duct facing surfaces of the duct connection portions face each other. Accordingly, for the adjacent duct divided bodies, the duct welding rib of the duct connection portion at the one end portion and the duct welding rib of the duct connection portion adjacent thereto are positioned in the above-described direction. With this positioning, the two duct welding ribs can be brought close to each other and welded together in a state where the duct welding rib of the duct connection portion at the one end portion and the duct welding rib of the duct connection portion adjacent thereto are made to face each other. Then, welding in the positioned state is performed on all the duct divided bodies.

(5) In the vehicle beam of the aspect, the duct body portion is divided into two duct divided bodies as the plurality of duct divided bodies,
the duct connection portions of each of the duct divided bodies are positioned on both sides of the flow path in a radial direction of the duct body portion, and
for each of the duct divided bodies, the duct facing surface of the duct connection portion on the one end portion faces in a direction different from and intersecting with a direction in which the duct facing surface of the duct connection portion on the other end portion faces.

According to the above configuration, for each of the duct divided bodies, the duct facing surface of the duct connection portion at the one end portion faces in a direction intersecting the direction in which the duct facing surface of the duct connection portion at the other end portion faces. Therefore, when two duct divided bodies approach each other and the duct welding ribs of adjacent duct connection portions approach each other before the welding, for example, the duct welding rib of the duct connection portion at the one end portion and the duct welding rib of the duct connection portion adjacent thereto come into contact with each other. By this contact, the two duct divided bodies are positioned in the direction in which the duct facing surfaces of the duct connection portions face each other. Accordingly, in the two duct divided bodies, the duct welding rib of the duct connection portion at the other end portion and the duct welding rib of the duct connection portion adjacent thereto are positioned in the above-described direction. With this positioning, the two duct welding ribs can be brought close to each other and welded together in a state where the duct welding rib of the duct connection portion at the other end portion and the duct welding rib of the duct connection portion adjacent thereto are made to face each other.

As described above, when two duct divided bodies approach each other and the duct welding ribs of adjacent duct connection portions approach each other before the welding, for example, the duct welding rib of the duct connection portion at the other end portion and the duct welding rib of the duct connection portion adjacent thereto come into contact with each other. By this contact, the two duct divided bodies are positioned in the direction in which the duct facing surfaces of the duct connection portions face each other. Accordingly, in the two duct divided bodies, the duct welding rib of the duct connection portion at the one end portion and the duct welding rib of the duct connection portion adjacent thereto are positioned in the above-described direction. With this positioning, the two duct welding ribs can be brought close to each other and welded together in a state where the duct welding rib of the duct connection portion at the one end portion and the duct welding rib of the duct connection portion adjacent thereto are made to face each other.

(6) In the vehicle beam of the aspect, the peripheral portion includes an intake duct portion that protrudes outward in a radial direction of the duct body portion from the duct body portion and takes air outside the duct body portion into the flow path,
the intake duct portion is divided into a plurality of intake duct divided bodies in the circumferential direction of the duct body portion,
each of the intake duct divided bodies is formed with an intake connection portion at a boundary with an adjacent intake duct divided body,
the intake duct divided bodies adjacent to each other are coupled by joining a pair of adjacent intake connection portions to each other,
at least one of the adjacent intake connection portions is formed with an intake welding rib that extends in a direction intersecting a direction in which the pair of intake connection portions face each other and that is connected to the duct welding rib of the duct divided body, and
the adjacent intake connection portions are joined together by welding the pair of intake connection portions at the intake welding rib.

According to the above configuration, adjacent intake duct divided bodies are coupled by joining adjacent intake connection portions together. The above-mentioned coupling is performed for all the intake duct divided bodies to form the intake duct portion. The adjacent intake connection portions are joined to each other by welding the intake connection portions at the intake welding rib. The intake welding rib extends in the direction intersecting the direction in which adjacent intake connection portions face each other, and is connected to the duct welding rib of the duct divided body. Accordingly, the sealing performance of the joint portion between the adjacent intake connection portions is ensured, and the phenomenon in which the air flowing through the intake duct portion leaks out from the joint portion is reduced.

Further, since the adjacent intake connection portions are joined by welding, the number of welded locations is increased, and the welding strength of the entire vehicle beam is improved.

(7) In the vehicle beam of the aspect, the duct body portion is further divided into a plurality of duct body components in the vehicle width direction, and the duct body components adjacent to each other are coupled by welding.

According to the above configuration, since the duct body portion is divided into the plurality of duct body components in the vehicle width direction, a length of each duct body component in the same direction is shorter than a length of the duct body portion not divided in the same direction. Therefore, welding can be performed with a smaller welding facility, for example, with an existing welding facility, than in the case where the duct body portion is not divided. In addition, compared to a case of welding the duct divided bodies of the duct body portion which is not divided, welding accuracy is easily achieved. Further, a part of the plurality of duct body components can be used for the vehicle beam mounted on different types of vehicles, so that so-called part standardization can be achieved.

(8) In the vehicle beam of the aspect, each of the duct body components is formed with an auxiliary connection portion at a boundary with an adjacent duct body component,
the duct body components adjacent to each other are coupled by joining the adjacent auxiliary connection portions to each other,
the adjacent auxiliary connection portions have a pair of auxiliary facing surfaces that face each other in the vehicle width direction,
the auxiliary facing surface of at least one of the adjacent auxiliary connection portions is formed with an auxiliary welding rib having an annular shape and surrounding the flow path, and
the adjacent auxiliary connection portions are joined together by welding the adjacent auxiliary connection portions at the auxiliary welding rib.

According to the above configuration, the duct body components adjacent to each other in the vehicle width direction are coupled by joining the adjacent auxiliary connection portions to each other in the same direction. The above-mentioned coupling is performed for all the duct body components to form the duct body portion. The adjacent auxiliary connection portions are joined to each other by welding the auxiliary connection portions at the auxiliary welding rib. The auxiliary welding rib is formed in an annular shape so as to surround the flow path with respect to the auxiliary facing surface on at least one of the adjacent auxiliary connection portions. Accordingly, the sealing performance of the joint portion between the adjacent auxiliary connection portions is ensured, and the phenomenon in which the air flowing through the duct body portion leaks out from the joint portion is reduced.

(9) In the vehicle beam of the aspect, in a case where one of the adjacent duct body components is defined as a first duct body component, and an other one of the adjacent duct body components is defined as a second duct body component,
the first duct body component includes a first tube portion at an end portion in the vehicle width direction, and
the second duct body component includes a second tube portion at an end portion in the vehicle width direction,
the second tube portion is inserted into the first tube portion such that the first tube portion of the first duct body component overlaps with the second tube portion of the second duct body component in a radial direction of the first tube portion and the second tube portion, and
a linear welding rib extending in the vehicle width direction is formed on at least one of an inner circumferential surface of the first tube portion or an outer circumferential surface of the second tube portion, and the first duct body component and the second duct body component are coupled by welding the first tube portion and the second tube portion at the linear welding rib.

According to the above configuration, when coupling the first duct body component and second duct body component adjacent in the width direction, the second tube portion is inserted into the first tube portion. Thus, the first tube portion of the first duct body component overlaps the second tube portion of the second duct body component in the radial direction. The first tube portion and the second tube portion are welded to each other by the linear welding rib formed on at least one of the inner circumferential surface of the first tube portion or the outer circumferential surface of the second tube portion.

Since the first tube portion and the second tube portion overlap each other in the radial direction, the joint strength of the first duct body component and the second duct body component is increased. Further, since the first tube portion and the second tube portion are joined by welding the linear welding ribs, the joint strength is further increased.

(10) In the vehicle beam of the aspect, in a case where one of the adjacent duct body components is defined as a first duct body component, and an other one of the adjacent duct body components is defined as a second duct body component,
the first duct body component includes a first tube portion at an end portion in the vehicle width direction, and
the second duct body component includes a second tube portion at an end portion in the vehicle width direction,
the second tube portion is inserted into the first tube portion such that the first tube portion of the first duct body component overlaps with the second tube portion of the second duct body component in a radial direction of the first tube portion and the second tube portion, and
an annular welding rib extending in the circumferential direction of the duct body portion is formed on at least one of an inner circumferential surface of the first tube portion or an outer circumferential surface of the second tube portion, and the first duct body component and the second duct body component are coupled by welding the first tube portion and the second tube portion at the annular welding rib.

According to the above configuration, when coupling the first duct body component and second duct body component adjacent in the width direction, the second tube portion is inserted into the first tube portion. Thus, the first tube portion of the first duct body component overlaps the second tube portion of the second duct body component in the radial direction. The first tube portion and the second tube portion are welded to each other by the annular welding rib formed on at least one of the inner circumferential surface of the first tube portion or the outer circumferential surface of the second tube portion.

Accordingly, the first tube portion and the second tube portion overlap each other in the radial direction, so that the joint strength of the first duct body component and the second duct body component is increased. Further, since the first tube portion and the second tube portion are joined by welding the annular welding ribs, the joint strength is further increased.

(11) In the vehicle beam of the aspect, the duct body portion and the peripheral portion are disposed above a steering column of the vehicle,
the duct body portion is divided into, as the plurality of duct divided bodies, an upper duct divided body and a lower duct divided body located below the upper duct divided body,
the peripheral portion includes:
   an upper support portion connected to the upper duct divided body; and
   a lower support portion connected to the lower duct divided body, the upper support portion includes:
   an upper front support portion disposed on a front side of the upper duct divided body and connected to the duct connection portion on the front side of the upper duct divided body; and
   an upper rear support portion disposed on a rear side of the upper duct divided body and connected to the duct connection portion on the rear side of the upper duct divided body,
the lower support portion includes:
   a lower front support portion which is connected at a rear end portion thereof to the lower duct divided body and has a portion disposed on a lower side of the upper front support portion; and
   a lower rear support portion which is disposed on a rear side of the lower duct divided body and on a lower side of the upper rear support portion and is connected to the duct connection portion on the rear side of the lower duct divided body, and
at least one of the upper front support portion or the lower front support portion is provided with a portion where the steering column is suspended in front of the duct body portion, and each of the upper rear support portion and the lower rear support portion is provided with a portion where the steering column is suspended at a rear of the duct body portion.

According to the above configuration, the steering column, which is disposed below the duct body portion and the peripheral portion, is suspended from the peripheral portion on the front side of the duct body portion and the peripheral portion on the rear side.

Here, if the duct body portion is divided into two duct divided bodies in the front-rear direction, the steering column is suspended from a front peripheral portion connected to a front duct divided body in front of the duct body portion. Further, the steering column is suspended from a rear peripheral portion connected to a rear duct divided body on the rear side of the duct body portion. In this case, a load of the steering column is received by the front peripheral portion in front of the duct body portion. In addition, the load is received by the rear peripheral portion on the rear side of the duct body portion.

In contrast, according to the above configuration, the steering column is suspended from at last one of the upper front support portion or the lower front support portion in front of the duct body portion. In addition, the steering column is suspended from the upper rear support portion and the lower rear support portion in the rear side of the duct body portion.

In this case, the load of the steering column is received by one or two front support portions in front of the duct body portion. Further, the load is received by two upper and lower rear support portions on the rear side of the duct body portion. Such a way of receiving the load can be achieved by dividing the duct body portion into two upper and lower duct divided bodies (the upper duct divided body and the lower duct divided body).

Therefore, compared to a case where the duct body portion is divided into two front and rear duct divided bodies, the above configuration is advantageous in terms of receiving the load of the steering column.

(12) In the vehicle beam of the aspect, at least one of the pair of duct facing surfaces of the adjacent duct connection portions is formed with, at a location spaced apart from the duct welding rib in a radial direction of the duct body portion, a trap rib configured to trap a burr generated during welding between the pair of duct facing surfaces, and
the trap rib extends along the pair of duct facing surfaces in a direction intersecting the facing direction.

In a case where a burr is generated when the adjacent duct connection portions are welded at the duct welding ribs, if a structure for restricting movement of the burr is not provided, there is a risk that the burr may come out from between the two duct facing surfaces.

In this regard, according to the above configuration, the trap rib provided at the location spaced apart from the duct welding rib in the radial direction of the duct body portion restricts movement of the burr between the pair of duct facing surfaces. When the burr moves, a part of each of the trap rib, the duct welding rib, and the duct facing surface provided in the duct connection portion serves as a wall, and the burr is captured by restricting the movement of the burr. A burr that is not captured changes the movement direction. When the burr changes the movement direction along the shape of the trap rib or the like, the number of times that movement of the burrs is restricted by the walls increases. Accordingly, the opportunity to capture the burr increases, and the amount of burr captured between the pair of facing surfaces increases. In addition, the trap rib extends in a direction intersecting the facing direction along the pair of duct facing surfaces. Therefore, the trap rib acts to capture the burr in a wide region in the intersecting direction. In this way, the phenomenon in which the burr comes out from between the pair of two duct facing surfaces is reduced.

(13) In the vehicle beam of the aspect, the trap rib is formed on an inner side in the radial direction of the tubular duct body portion than the duct welding rib, the inner side being closer to the flow path for air in the radial direction of the duct body portion.

According to the above configuration, even if the burr generated by the welding attempts to move between the pair of duct facing surfaces to the inner side in the radial direction of the duct body portion than the duct welding rib, the movement is restricted by the trap rib. Therefore, a phenomenon of a burr getting into the duct body portion is restricted by the lower rear trap rib. A phenomenon in which the burr is carried to the vehicle compartment by the air flowing through the flow path in the duct body portion is restricted.

(14) In the vehicle beam of the aspect, a plurality of the trap ribs are provided,
two of the plurality of trap ribs are formed on each of the pair of duct facing surfaces of the adjacent duct connection portions at locations spaced apart from each other in the radial direction of the duct body portion,
the two trap ribs protrude in opposite directions along the facing direction in a state of being adjacent to each other in the radial direction, and
when the two trap ribs are viewed from the radial direction, a portion which is a part of one of the trap ribs in the facing direction and includes a tip end portion of the one trap rib overlaps in the facing direction with a portion which is a part of an other one of the trap ribs in the facing direction and includes a tip end portion of the other one trap rib.

According to the above configuration in which the trap ribs formed on each of the pair of duct facing surfaces partially overlap each other in the facing direction, the number of times that movement of the burrs is restricted by the walls increases as compared with a case where the same configuration is not provided. In addition, since the gap formed between the overlapping portions of the pair of trap ribs adjacent to each other in the radial direction of the duct body portion functions as a space for capturing the burr, the number of locations for capturing the burr increases. As a result, the phenomenon in which the burr comes out from between the pair of two duct facing surfaces is further reduced.

(15) In the vehicle beam of the aspect, the trap rib protrudes from one of the pair of duct facing surfaces of the adjacent duct connection portions toward an other one of the pair of duct facing surfaces,
a trap reinforcement portion made of a material softer than the trap rib is attached to the other one duct facing surface, and
at least a tip end portion of the trap rib in a protruding direction enters the trap reinforcement portion.

According to the above configuration, between the trap reinforcement portion and the portion of the upper rear trap rib that has entered the trap reinforcement portion, there is no gap or the gap is extremely small. Therefore, the burrs are less likely to pass through than if no trap reinforcement portion is provided. As a result, the burr does not protrude or hardly come out from between the pair of duct facing surfaces.

(16) In the vehicle beam of the aspect, the duct welding rib and the trap rib protrude in opposite directions along the facing direction in a state of being spaced apart from each other in the radial direction of the duct body portion,
the duct welding rib includes:
   a welding base portion located on a base end side in a protruding direction of the duct welding rib; and
   a welding tip portion adjacent to a tip end side in the protruding direction of the duct welding rib with respect to the welding base portion,
the trap rib includes:
   a trap base portion located on a base end side in a protruding direction of the trap rib; and
   a trap tip portion adjacent to a tip end side in the protruding direction of the trap rib with respect to the trap base portion,
the duct welding rib is formed such that a dimension of the welding tip portion in the radial direction is smaller than a dimension of the welding base portion in the radial direction,
the trap rib is formed such that a dimension of the trap tip portion in the radial direction is smaller than a dimension of the trap base portion in the radial direction, and
the trap base portion and the welding tip portion are spaced apart from each other in the radial direction via a first gap extending in the facing direction, the welding base portion and the trap tip portion are spaced apart from each other in the radial direction via a second gap extending in the facing direction, and the trap base portion and the welding base portion are spaced apart from each other in the facing direction via a communication gap that extends in the radial direction and communicates the first gap and the second gap.

According to the above configuration, when the burr moves between the trap rib and the duct welding rib so as to come out from between the pair of duct facing surfaces, the burr moves through the first gap, the communication gap, and the second gap in this order.

The burr comes into contact with the welding base portion when moving in the facing direction through the first gap. The welding base portion serves as a wall to restrict the movement of the burr in the facing direction, thereby attempting to capture the burr. The movement direction of the burr not captured by the welding base portion is changed from a direction approaching the welding base portion in the facing direction to a direction away from the welding tip portion in the radial direction of the duct body portion.

The burr comes into contact with the trap tip portion when moving in the radial direction through the communication gap. The trap tip portion serves as a wall to restrict the movement of the burr in the radial direction, thereby attempting to capture the burr. The movement direction of the burr not captured by the trap tip portion is changed from a direction from the welding tip portion toward the trap tip portion in the radial direction to a direction opposite to the protruding direction of the duct welding rib in the facing direction.

The burr comes into contact with the duct facing surface on which the duct welding rib is formed in the process of moving through the second gap. The duct facing surface serves as a wall to restrict the movement of the burr in the facing direction, thereby attempting to capture the burr. The movement direction of the burr not captured by the duct facing surface is changed to a direction away from the welding base portion in the radial direction. The burr whose movement direction is changed passes through the gap between the duct facing surface and the trap tip portion.

In this way, the number of times that movement of the burrs is restricted by the walls increases, and accordingly, the opportunity to capture the burrs is increased. The amount of burrs captured between the pair of duct facing surfaces increases.

The gap between the trap rib and the duct welding rib functions as a space that traps the burrs. In this regard, a total volume of the first gap, the communication gap, and the second gap is larger than a total volume of the first gap and the second gap directly connected to each other without the communication gap interposed therebetween. Therefore, it is possible to trap more burrs.

According to the aspects of the present disclosure, it is possible to improve the sealing performance of a joint portion between adjacent beam connection portions.

### BRIEF DESCRIPTION OF DRAWINGS

Exemplary embodiment(s) of the present invention will be described in detail based on the following figures, wherein:

FIG. 1 is a perspective view showing an entire vehicle beam according to a first embodiment;

FIG. 2 is a perspective view showing a lower half of the vehicle beam according to the first embodiment;

FIG. 3 is a cross-sectional view taken along a line 3-3 in FIG. 1;

FIG. 4 is an enlarged cross-sectional view of a portion X shown in FIG. 3;

FIG. 5 is a cross-sectional view taken along a line 5-5 in FIG. 1;

FIG. 6 is a cross-sectional view taken along a line 6-6 of FIG. 1;

FIG. 7 is a partial perspective view of a lower duct divided body according to the first embodiment;

FIG. 8 is a partial perspective view of an upper duct divided body according to the first embodiment;

FIG. 9 is a view showing a second embodiment, and is a cross-sectional view corresponding to FIG. 5;

FIG. 10 is a partial perspective view of a lower duct divided body according to the second embodiment;

FIG. 11 is a partial perspective view of an upper duct divided body according to the second embodiment;

FIG. 12 is a view showing a third embodiment, and is a partial cross-sectional side view showing a state where first and second duct body components are coupled;

FIG. 13 is a partial perspective view of a duct body portion according to the third embodiment;

FIG. 14 is a view showing a fourth embodiment, and is a partial cross-sectional side view showing a state before first and second duct body components are coupled;

FIG. 15 is a view showing a fifth embodiment, and is a partial cross-sectional side view showing a state before first and second duct body components are coupled;

FIG. 16 is a view showing a sixth embodiment, and is a cross-sectional view corresponding to FIG. 5;

FIG. 17 is an enlarged cross-sectional view of a portion Y shown in FIG. 16;

FIG. 18 is a partially exploded cross-sectional view showing a state before an upper rear connection portion and a lower rear connection portion are joined by welding in the sixth embodiment;

FIG. 19 is a view showing a seventh embodiment, and is a partial cross-sectional view corresponding to FIG. 17;

FIG. 20 is a partially exploded cross-sectional view showing a state before an upper rear connection portion and a lower rear connection portion are joined by welding in the seventh embodiment;

FIG. 21 is a view showing an eighth embodiment, and is a partial cross-sectional view corresponding to FIG. 17;

FIG. 22 is a partially exploded cross-sectional view showing a state before a trap reinforcement portion is attached to a lower rear connection portion in the eighth embodiment;

FIG. 23 is a partially exploded cross-sectional view showing a state before an upper rear connection portion and the lower rear connection portion are joined by welding in the eighth embodiment; and

FIG. 24 is a view showing a modification of the sixth embodiment, and is a partial cross-sectional view of the upper rear connection portion and the lower rear connection portion joined to each other by welding.

### DESCRIPTION OF EMBODIMENTS

### First Embodiment

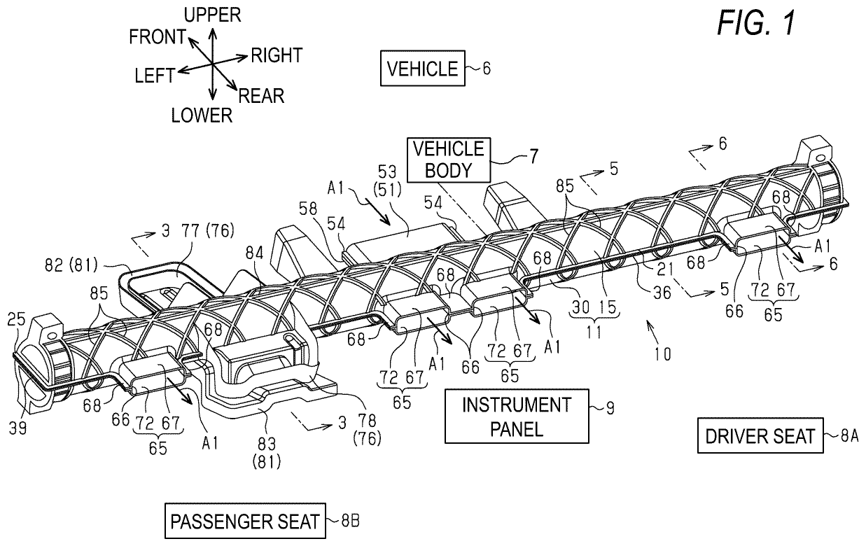

Hereinafter, a vehicle beam according to a first embodiment will be described with reference to FIGS. 1 to 8.

In the following description, a forward moving direction of a vehicle 6 is referred to as the front, and a backward moving direction of the vehicle 6 is referred to as the rear. In addition, in the following description, an upper-lower direction refers to an upper-lower direction of the vehicle 6, and a left-right direction refers to a width direction of the vehicle 6, which coincides with a left-right direction when the vehicle is moving forward.

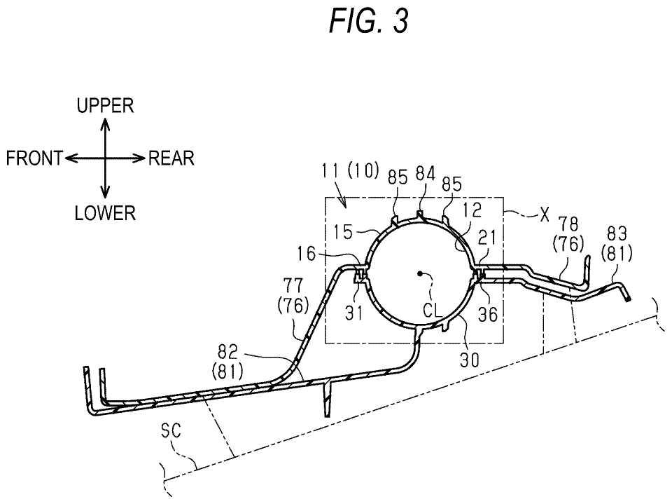

As shown in FIGS. 1 and 3, an instrument panel 9 is provided in front of a driver seat 8A and a passenger seat 8B of the vehicle 6. A vehicle beam 10 extending in the left-right direction is disposed inside the instrument panel 9 and above a steering column SC indicated by a two-dot chain line in FIG. 3. The vehicle beam 10 is attached to a vehicle body 7 and supports the instrument panel 9.

A shell of the vehicle beam 10 is constituted by a beam shell portion formed in a tubular shape and made of a resin material. Next, a schematic configuration of the beam shell portion will be described. The tubular beam shell portion is divided into a plurality of beam divided bodies in a circumferential direction of the beam shell portion. Each beam divided body has a beam connection portion at a boundary with an adjacent beam divided body. Adjacent beam divided bodies are coupled by joining adjacent beam connection portions together. The adjacent beam connection portions have a pair of beam facing surfaces that face each other. A beam welding rib is formed along the pair of beam facing surfaces on the beam facing surface of at least one of the adjacent beam connection portions, extending in a direction intersecting a direction in which the beam facing surfaces face each other. The adjacent beam connection portions are joined to each other by welding the beam connection portions at the beam welding rib.

The vehicle beam 10 includes a duct body portion 11 and a peripheral portion, each of which is formed using a resin material. In the first embodiment, a polyamide resin reinforced with glass fibers is used as the resin material. Alternatively, other resin materials may be used.

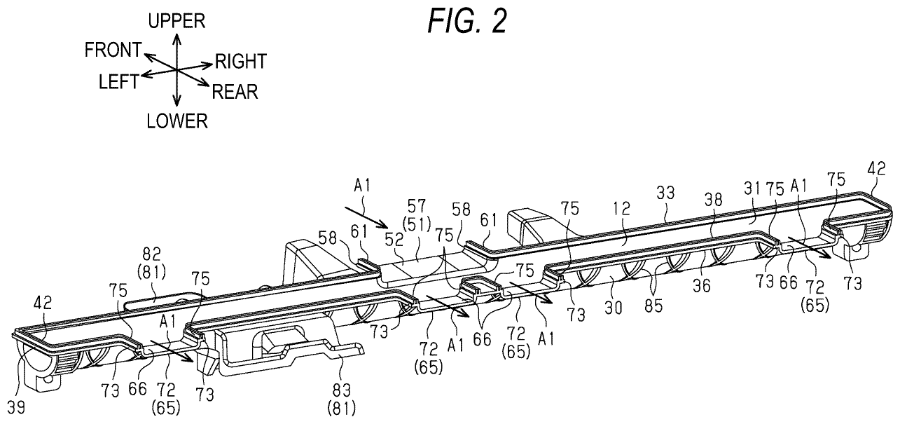

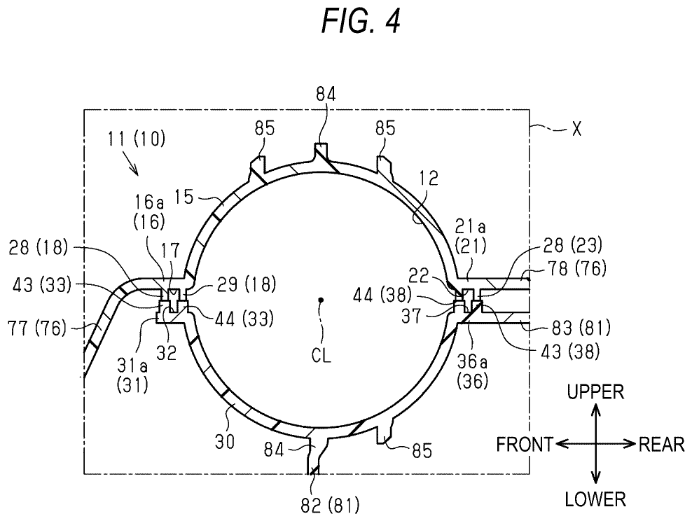

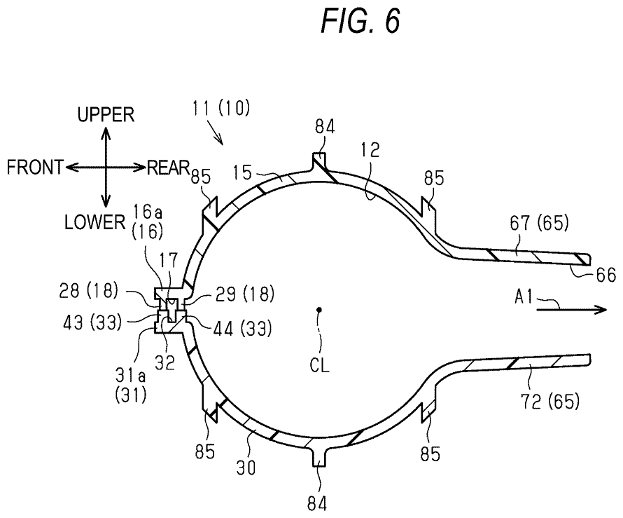

As shown in FIGS. 4 to 6, the duct body portion 11 is a portion constituting a framework of the vehicle beam 10. The duct body portion 11 constitutes the beam shell portion. The duct body portion 11 has a tubular shape and has a flow path 12 for air A1 (see FIGS. 2 and 6). Both end portions of the duct body portion 11 in the left-right direction are closed. The duct body portion 11 according to the first embodiment has a circular cross section on a vertical plane extending in the front-rear direction and the upper-lower direction of the vehicle 6. The duct body portion 11 has a central axis CL that passes through the center of the circular cross section and extends in the left-right direction.

In order to identify each part of the duct body portion 11, a direction radially extending from the central axis CL is referred to as a radial direction. In a circle having a center on the central axis CL, a direction along the circle is referred to as a circumferential direction. In addition, with reference to the flow path 12, in the above radial direction, a side closer to the flow path 12 may be referred to as “inner”, “inner side” or the like, and a side away from the flow path 12 may be referred to as “outer”, “outer side” or the like.

Next, the duct body portion 11 will be described in detail.

### Upper Duct Divided Body 15 and Lower Duct Divided Body 30

The duct body portion 11 is divided into a plurality of duct divided bodies in the circumferential direction. The plurality of beam divided bodies of the beam shell portion are formed by the plurality of duct divided bodies of the duct body portion. In the first embodiment, the duct body portion 11 is divided into two parts: an upper duct divided body 15 that forms an upper half of the duct body portion 11, and a lower duct divided body 30 that is adjacent to a lower side of the upper duct divided body 15 and forms a lower half of the duct body portion 11.

### Connection Portion

The upper duct divided body 15 has a semicircular cross section on the vertical plane. A lower end of the upper duct divided body 15 is open. The upper duct divided body 15 has a duct connection portion as the beam connection portion at a boundary with the lower duct divided body 30. In other words, the upper duct divided body 15 has the duct connection portion as the beam connection portion at each of both end portions in the circumferential direction. The two duct connection portions are located on both side portions of the flow path 12 in the radial direction. The duct connection portions of the upper duct divided body 15 are located in a front portion and a rear portion of the flow path 12 in the radial direction. Here, in order to distinguish between the two duct connection portions, the duct connection portion located on a front side of the flow path 12 is referred to as an “upper front connection portion 16”, and the duct connection portion located on a rear side of the flow path 12 is referred to as an “upper rear connection portion 21”. The upper front connection portion 16 has a flange portion 16a protruding outward, in this case, forward in the radial direction from the upper duct divided body 15. The upper rear connection portion 21 has a flange portion 21a protruding outward, in this case, rearward in the radial direction from the upper duct divided body 15.

The lower duct divided body 30 has a semicircular cross section on the vertical plane. An upper end of the lower duct divided body 30 is open. The lower duct divided body 30 has a duct connection portion as the beam connection portion at a boundary with the upper duct divided body 15. In other words, the lower duct divided body 30 has the duct connection portion as the beam connection portion at each of both end portions in the circumferential direction. The two duct connection portions are located on both side portions of the flow path 12 in the radial direction. The duct connection portions of the lower duct divided body 30 are located in the front portion and the rear portion of the flow path 12 in the radial direction. Here, in order to distinguish between the two duct connection portions, the duct connection portion located on a front side of the flow path 12 is referred to as an “lower front connection portion 31”, and the duct connection portion located on a rear side of the flow path 12 is referred to as an “lower rear connection portion 36”. The lower front connection portion 31 has a flange portion 31a protruding outward, in this case, forward in the radial direction from the lower duct divided body 30. The lower rear connection portion 36 has a flange portion 36a protruding outward, in this case, rearward in the radial direction from the lower duct divided body 30.

Although detailed description is omitted, as shown in FIGS. 1 and 2, the upper duct divided body 15 has upper end connection portions 25 at both end portions in the left-right direction. Similarly, the lower duct divided body 30 has lower end connection portions 39 at both end portions in the left-right direction.

As shown in FIGS. 4 to 6, the upper duct divided body 15 and the lower duct divided body 30 are coupled to each other by joining in the following portions.

The upper front connection portion 16 and the lower front connection portion 31 are joined together.

The upper rear connection portion 21 and the lower rear connection portion 36 are joined together.

The upper end connection portions 25 and the lower end connection portions 39 adjacent to each other in the upper-lower direction are joined together (see FIG. 1).

### Facing Surfaces

A pair of duct connection portions adjacent to each other in the upper-lower direction face each other in the same direction and have a pair of duct facing surfaces that form a pair of beam facing surfaces.

More specifically, the upper front connection portion 16 and the lower front connection portion 31 are adjacent to each other in the upper-lower direction as described above. The upper front connection portion 16 has, on a lower surface thereof, an upper front facing surface 17 which extends in the front-rear direction and the left-right direction while facing downward. The lower front connection portion 31 has, on an upper surface thereof, a lower front facing surface 32 which extends in the front-rear direction and the left-right direction while facing downward. The upper front facing surface 17 and the lower front facing surface 32 face each other in the upper-lower direction. The upper front facing surface 17 and the lower front facing surface 32 form a pair of duct facing surfaces and also a pair of beam facing surfaces.

The upper rear connection portion 21 and the lower rear connection portion 36 are adjacent to each other in the upper-lower direction as described above. The upper rear connection portion 21 has, on a lower surface thereof, an upper rear facing surface 22 which extends in the front-rear direction and the left-right direction while facing downward. The lower rear connection portion 36 has, on an upper surface thereof, a lower rear facing surface 37 which extends in the front-rear direction and the left-right direction while facing downward. The upper rear facing surface 22 and the lower rear facing surface 37 face each other in the upper-lower direction. The upper rear facing surface 22 and the lower rear facing surface 37 form a pair of duct facing surfaces and also a pair of beam facing surfaces.

### Duct Welding Rib

Here, a direction in which a pair of duct facing surfaces face each other is defined as a facing direction. The facing direction for the upper front facing surface 17 and the lower front facing surface 32 is the upper-lower direction. The facing direction of the upper rear facing surface 22 and the lower rear facing surface 37 is the upper-lower direction.

On each of the pair of adjacent duct facing surfaces, two types of duct welding ribs, inner and outer, extending along both duct facing surfaces in a direction intersecting the facing direction are formed as the beam welding ribs. The intersecting direction includes a direction intersecting (orthogonal to) the facing direction at 90°, and also a direction intersecting at an angle other than 90°, that is, an inclined direction.

Further, the duct welding rib formed on one duct facing surface and the duct welding rib formed on the other duct facing surface face each other in the facing direction.

The duct welding ribs are described below.

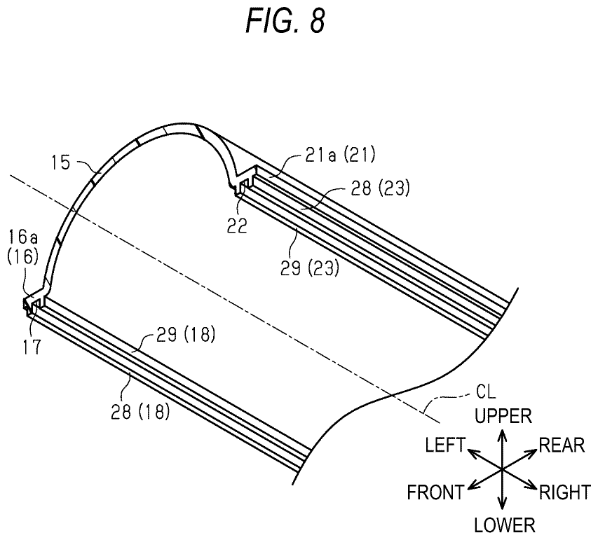

As shown in FIG. 8, two upper front welding ribs 18 are formed on the upper front facing surface 17 in a manner of extending in the left-right direction while being spaced apart and parallel to each other in the front-rear direction.

Two upper rear welding ribs 23 are formed on the upper rear facing surface 22 in a manner of extending in the left-right direction while being spaced apart and parallel to each other in the front-rear direction.

Two upper end welding ribs (not shown) are formed on each of the left and right upper end connection portions 25 (see FIG. 1) in a manner of extending in the front-rear direction while being spaced apart and parallel to each other in the left-right direction.

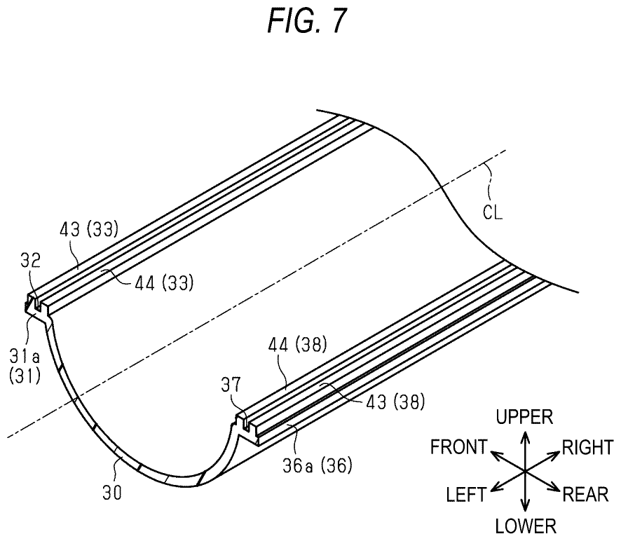

As shown in FIG. 7, two lower front welding ribs 33 are formed on the lower front facing surface 32 in a manner of extending in the left-right direction while being spaced apart and parallel to each other in the front-rear direction.

Two lower rear welding ribs 38 are formed on the lower rear facing surface 37 in a manner of extending in the left-right direction while being spaced apart and parallel to each other in the front-rear direction.

Two lower end welding ribs 42 (see FIG. 2) are formed on each of the left and right lower end connection portions 39 in a manner of extending in the front-rear direction while being spaced apart and parallel to each other in the left-right direction.

An outer upper welding rib 28 is formed by the upper front welding rib 18, the upper rear welding rib 23, and both the left and right upper end welding ribs, each of which being located on the outer side. Similarly, an inner upper welding rib 29 is formed by the upper front welding rib 18, the upper rear welding rib 23, and both the left and right upper end welding ribs, each of which being located on the inner side.

Further, an outer lower welding rib 43 is formed by the lower front welding rib 33, the lower rear welding rib 38, and both the left and right lower end welding ribs 42, each of which being located on the outer side. Similarly, an inner lower welding rib 44 is formed by the lower front welding rib 33, the lower rear welding rib 38, and both the left and right lower end welding ribs 42, each of which being located on the inner side.

### Joining of Adjacent Duct Connection Portions

The duct connection portions adjacent to each other are joined by welding a pair of duct welding ribs facing each other in the facing direction to each other by a welding method such as infrared (IR) welding, hot plate welding, or vibration welding.

As shown in FIGS. 4 to 6, the upper front connection portion 16 and the lower front connection portion 31 are joined by welding the upper front welding ribs 18 and the lower front welding ribs 33 located below the upper front welding ribs 18.

The upper rear connection portion 21 and the lower rear connection portion 36 are joined by welding the upper rear welding ribs 23 and the lower rear welding ribs 38 located below the upper rear welding ribs 23.

The upper end connection portion 25 and the lower end connection portion 39 adjacent to each other in the upper-lower direction are joined by welding the upper end welding ribs and the lower end welding ribs 42 located below the upper end welding ribs (see FIG. 2).

The adjacent duct divided bodies are coupled by the joining described above, and therefore the adjacent beam divided bodies are coupled.

As described above, the vehicle beam 10 includes the duct body portion 11 and the peripheral portion. As shown in FIGS. 1, 2, and 6, the peripheral portion is connected to the duct body portion 11. The peripheral portion includes an intake duct portion 51 and outlet duct portions 65. Both the intake duct portion 51 and the outlet duct portions 65 protrude outward in the radial direction from the duct body portion 11. In the first embodiment, the peripheral portion includes one intake duct portion 51 and four outlet duct portions 65.

Next, each part forming the peripheral portion will be described.

### Intake Duct Portion 51

As shown in FIGS. 1 and 2, the intake duct portion 51 protrudes forward from the vicinity of a central portion of the duct body portion 11 in the left-right direction. The intake duct portion 51 has a tubular shape that is flat in the upper-lower direction, and has an inflow path 52 for the air A1. The inflow path 52 communicates with the flow path 12 of the duct body portion 11. The inflow path 52 serves to guide the air A1 sent from an air conditioning system outside the vehicle beam 10 to the flow path 12.

The intake duct portion 51 is divided into a plurality of intake duct divided bodies in the circumferential direction. In the first embodiment, the intake duct portion 51 is divided into two parts: an upper intake duct divided body 53 that forms an upper half of the intake duct portion 51, and a lower intake duct divided body 57 that is adjacent to the lower side of the upper intake duct divided body 53 and forms a lower half of the intake duct portion 51.

A lower end of the upper intake duct divided body 53 is open. The upper intake duct divided body 53 has two upper intake connection portions 54 at a boundary with the lower intake duct divided body 57. The two upper intake connection portions 54 extend in the front-rear direction at two locations spaced apart from each other in the left-right direction.

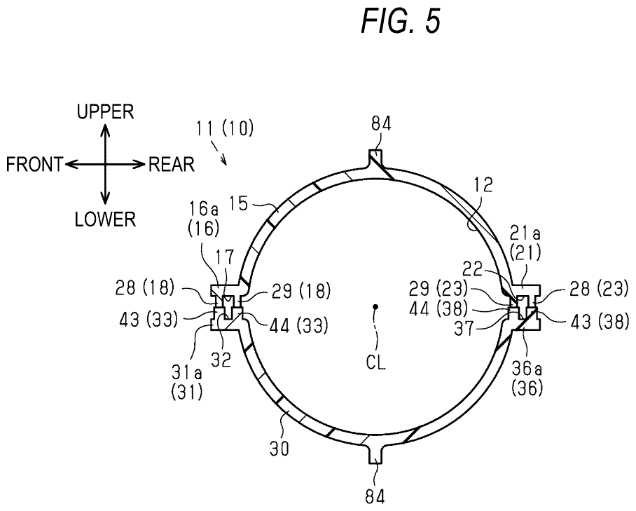

The upper front connection portion 16 (see FIG. 5 and the like) of the upper duct divided body 15 is disconnected at a location where the upper intake duct divided body 53 protrudes from the upper duct divided body 15. Rear end portions of the two upper intake connection portions 54 are connected to the upper front connection portion 16 at the disconnected location described above.

An upper end of the lower intake duct divided body 57 is open. The lower intake duct divided body 57 has two lower intake connection portions 58 at a boundary with the upper intake duct divided body 53. The two lower intake connection portions 58 extend in the front-rear direction at two locations spaced apart from each other in the left-right direction.

The lower front connection portion 31 (see FIG. 5 and the like) of the lower duct divided body 30 is disconnected at a location where the lower intake duct divided body 57 protrudes from the lower duct divided body 30. Rear end portions of the two lower intake connection portions 58 are connected to the lower front connection portion 31 at the disconnected location described above.

The upper intake duct divided body 53 and the lower intake duct divided body 57 are coupled to each other by joining the upper intake connection portions 54 and the lower intake connection portions 58 adjacent thereto on the lower side.

Each upper intake connection portion 54 is formed with two upper intake welding ribs (not shown) extending in a direction intersecting a direction in which the upper intake connection portion 54 and the lower intake connection portion 58 face each other. The two upper intake welding ribs are spaced apart and parallel to each other in the left-right direction. Of the two upper intake welding ribs of each upper intake connection portion 54, the upper intake welding rib on a side farther from the inflow path 52 is connected to the outer upper welding rib 28 (the upper front welding rib 18). The upper intake welding rib on a side closer to the inflow path 52 is connected to the inner upper welding rib 29 (the upper front welding rib 18).

Similarly, each lower intake connection portion 58 is formed with two lower intake welding ribs 61 extending in the direction intersecting the direction in which the upper intake connection portion 54 and the lower intake connection portion 58 face each other. The two lower intake welding ribs 61 are spaced apart and parallel to each other in the left-right direction. Of the two lower intake welding ribs 61 of each lower intake connection portion 58, the lower intake welding rib 61 on the side farther from the inflow path 52 is connected to the outer lower welding rib 43 (the lower front welding rib 33). The lower intake welding rib 61 on the side closer to the inflow path 52 is connected to the inner lower welding rib 44 (the lower front welding rib 33).

The intersecting direction includes a direction intersecting (orthogonal to) at 90° with respect to a direction in which the upper intake connection portion 54 and the lower intake connection portion 58 face each other, and also includes a direction intersecting at an angle other than 90°, that is, an inclined direction. In the first embodiment, both the upper intake welding ribs and both the lower intake welding ribs 61 extend in the front-rear direction, which is the intersecting direction.

The upper intake connection portion 54 and the lower intake connection portion 58 are joined by welding the upper intake welding ribs and the lower intake welding ribs 61 located below the upper intake welding ribs.

### Outlet Duct Portion 65

The four outlet duct portions 65 protrude outward in the radial direction, here, rearward of the duct body portion 11 from both side portions and the vicinity of a central portion of the duct body portion 11 in the left-right direction. The outlet duct portion 65 on the right side is located in front of the driver seat 8A. The outlet duct portion 65 on the left side is positioned in front of the passenger seat 8B. The two outlet duct portions 65 in the vicinity of the central portion are located in front of a boundary between the driver seat 8A and the passenger seat 8B. The four outlet duct portions 65 have the same configuration. Each of the outlet duct portions 65 has a tubular shape that is flat in the upper-lower direction, and has an outlet flow path 66 for the air A1. Each of the outlet flow paths 66 communicates with the flow path 12 of the duct body portion 11. Each outlet flow path 66 serves to guide the air A1 flowing through the flow path 12 to a duct (not shown) provided between the outlet duct portion 65 and an outlet port of the instrument panel 9 for the air A1.

Each of the outlet duct portions 65 is divided into a plurality of outlet duct divided bodies in the circumferential direction. In the first embodiment, each of the outlet duct portions 65 is divided into two parts: an upper outlet duct divided body 67 that forms an upper half of the outlet duct portion 65, and a lower outlet duct divided body 72 that is adjacent to the lower side of the upper outlet duct divided body 67 and forms a lower half of the outlet duct portion 65.

As shown in FIGS. 1, 2, and 6, a lower end of the upper outlet duct divided body 67 is open. The upper outlet duct divided body 67 has two upper outlet connection portions 68 at a boundary with the lower outlet duct divided body 72. The two upper outlet connection portions 68 extend in the front-rear direction at two locations spaced apart from each other in the left-right direction.

The upper rear connection portion 21 (see FIG. 5 and the like) is disconnected at a location where the upper outlet duct divided body 67 protrudes from the upper duct divided body 15. Front end portions of the two left and right upper outlet connection portions 68 are connected to the upper rear connection portion 21 at the disconnected location described above.

As shown in FIG. 2, an upper end of the lower outlet duct divided body 72 is open. The lower outlet duct divided body 72 has two lower outlet connection portions 73 at a boundary with the upper outlet duct divided body 67. The two lower outlet connection portions 73 extend in the front-rear direction at two locations spaced apart from each other in the left-right direction.

The lower rear connection portion 36 (see FIG. 5 and the like) is disconnected at a location where the lower outlet duct divided body 72 protrudes from the lower duct divided body 30. Front end portions of the two lower outlet connection portions 73 are connected to the lower rear connection portion 36 at the disconnected location described above.

As shown in FIGS. 1 and 2, the upper outlet duct divided body 67 and the lower outlet duct divided body 72 are coupled to each other by joining the upper outlet connection portions 68 and the lower outlet connection portions 73.

Each upper outlet connection portion 68 is formed with two upper outlet welding ribs (not shown) extending in a direction intersecting a direction in which the upper outlet connection portion 68 and the lower outlet connection portion 73 face each other. The two upper outlet welding ribs are spaced apart and parallel to each other in the left-right direction. Of the two upper outlet welding ribs of each upper outlet connection portion 68, the upper outlet welding rib on a side farther from the outlet flow path 66 is connected to the outer upper welding rib 28 (the upper rear welding rib 23). The upper outlet welding rib on a side closer to the outlet flow path 66 is connected to the inner upper welding rib 29 (the upper rear welding rib 23).

Similarly, each lower outlet connection portion 73 is formed with two lower outlet welding ribs 75 extending in the direction intersecting the direction in which the upper outlet connection portion 68 and the lower outlet connection portion 73 face each other. The two lower outlet welding ribs 75 are spaced apart and parallel to each other in the left-right direction. Of the two lower outlet welding ribs 75 of each lower outlet connection portion 73, the lower outlet welding rib 75 on the side farther from the outlet flow path 66 is connected to the outer lower welding rib 43 (the lower rear welding rib 38). The lower outlet welding rib 75 on the side closer to the outlet flow path 66 is connected to the inner lower welding rib 44 (the lower rear welding rib 38).

The intersecting direction includes a direction intersecting (orthogonal to) at 90° with respect to a direction in which the upper outlet connection portion 68 and the lower outlet connection portion 73 face each other, and also includes a direction intersecting at an angle other than 90°, that is, an inclined direction. In the first embodiment, both the upper outlet welding ribs and both the lower outlet welding ribs 75 extend in the front-rear direction, which is the intersecting direction.

The upper outlet connection portion 68 and the lower outlet connection portion 73 are joined by welding the upper outlet welding ribs and the lower outlet welding ribs 75 located below the upper outlet welding ribs.

### Upper Support Portion 76 and Lower Support Portion 81

As shown in FIGS. 1, 3 and 4, the peripheral portion further includes an upper support portion 76 connected to the upper duct divided body 15 and a lower support portion 81 connected to the lower duct divided body 30.

The upper support portion 76 includes an upper front support portion 77 and an upper rear support portion 78. The upper front support portion 77 is disposed on the front side of the upper duct divided body 15, and is connected to the upper front connection portion 16 at a rear end portion thereof. The upper rear support portion 78 is disposed on the rear side of the upper duct divided body 15, and is connected to the upper rear connection portion 21 at a front end portion thereof.

The lower support portion 81 includes a lower front support portion 82 and a lower rear support portion 83. The lower front support portion 82 is connected to a lower end portion of the lower duct divided body 30 at a rear end portion thereof. In the first embodiment, the rear end portion of the lower front support portion 82 is connected from below to a central portion of the lower duct divided body 30 in the front-rear direction. The lower front support portion 82 has a portion that is disposed adjacent to the lower side of the upper front support portion 77, or in other words, a portion that is overlapped with the upper front support portion 77.

The lower rear support portion 83 is disposed on the rear side of the lower duct divided body 30. The lower rear support portion 83 has a portion disposed on the lower side of the upper rear support portion 78. A front end portion of the lower rear support portion 83 is connected to the lower rear connection portion 36.

At least one of the upper front support portion 77 or the lower front support portion 82 is provided with a portion where the steering column SC is suspended in front of the duct body portion 11. Each of the upper rear support portion 78 and the lower rear support portion 83 is provided with a portion where the steering column SC is suspended in a rear of the duct body portion 11.

As indicated by a two-dot chain line in FIG. 3, the steering column SC is suspended from the above-mentioned portion of at least one of the upper front support portion 77 or the lower front support portion 82 in front of the duct body portion 11. The steering column SC is suspended from the above-mentioned portions of the upper rear support portion 78 and the lower rear support portion 83 in the rear side of the duct body portion 11.

Further, as shown in FIGS. 1, 2, and 6, in the first embodiment, two upper and lower reinforcing ribs 84 and two types of reinforcing ribs 85 are integrally formed on an outer circumferential surface of the duct body portion 11. The two reinforcing ribs 84 and the two reinforcing ribs 85 are formed to cover a region of the duct body portion 11 excluding both end portions in the left-right direction.

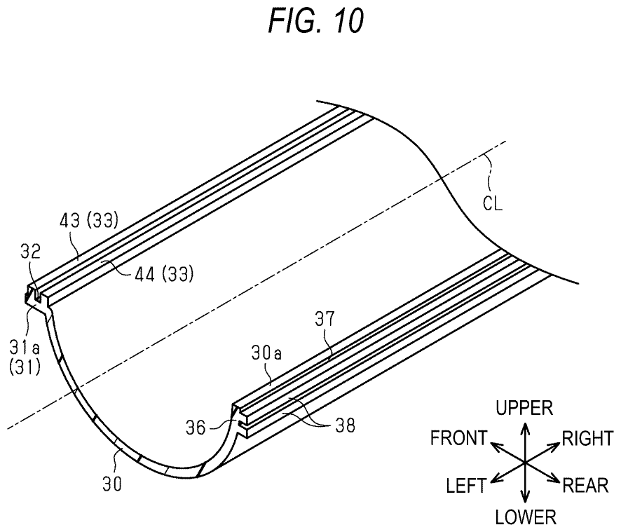

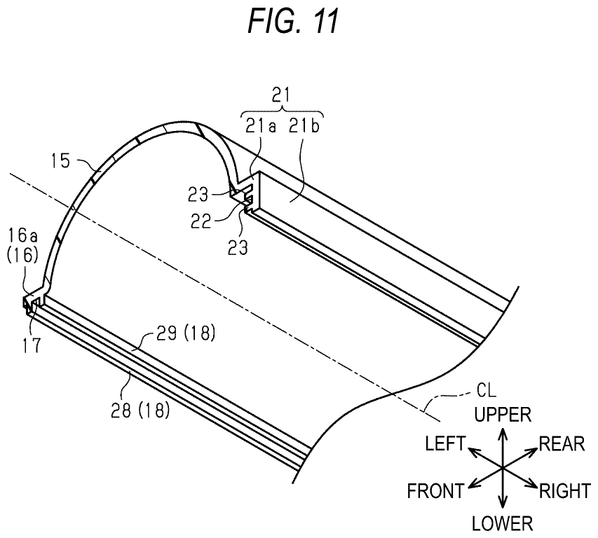

The two reinforcing ribs 84 extend in the left-right direction at an upper end portion (top portion) of the upper duct divided body 15 and the lower end portion (bottom portion) of the lower duct divided body 30. On the other hand, the two types of reinforcing ribs 85 are formed so as to spirally wind around the duct body portion 11 from right to left, or conversely, from left to right. One reinforcing rib 85 obliquely intersects the two reinforcing ribs 84 and the other reinforcing rib 85 at a plurality of locations in the left-right direction. In FIGS. 7 and 8, illustration of the reinforcing ribs 84 and 85 is omitted. The same applies to FIGS. 10 to 15 described later.

### Operations of First Embodiment

When manufacturing the vehicle beam 10, the duct connection portions adjacent to each other are joined by welding at the duct welding ribs. The corresponding duct connection portions are the upper front connection portion 16 and the lower front connection portion 31, the upper rear connection portion 21 and the lower rear connection portion 36, and the upper end connection portion 25 and the lower end connection portion 39. The corresponding duct welding ribs are the upper front welding ribs 18 and the lower front welding ribs 33, the upper rear welding ribs 23 and the lower rear welding ribs 38, and the upper end welding ribs and the lower end welding ribs 42.

Here, if the duct welding rib is formed on only one of a pair of duct facing surfaces that face each other, the duct welding rib is welded to the duct connection portion on the other duct facing surface. In this case, during welding of the duct welding rib, the temperature of a tip end surface of the duct welding rib is raised. On the other hand, during welding of the duct connection portion having the other duct facing surface, the temperature of a location facing the duct welding rib and a peripheral portion thereof in the other duct facing surface is raised. An area of the other duct facing surface that needs to be heated up is larger than the tip end surface of the duct welding rib. Therefore, heat is more likely to dissipate, and the efficiency of temperature rise is decreased.

In this regard, in the first embodiment, the duct welding ribs formed on the one duct facing surface and the duct welding ribs formed on the other duct facing surface face each other in the facing direction. The duct welding ribs are welded together. In this case, during welding of the duct welding ribs, the temperature of a tip end surface of each duct welding rib is raised. An area of a tip end surface of each duct welding rib that needs to be heated up is smaller than the area of the location of the duct facing surface that needs to be heated up. Therefore, heat is less likely to dissipate, and the efficiency of temperature rise is increased.

The operation related to the temperature increasing area and the temperature increasing efficiency of the duct welding rib is the same as the operation related to the temperature increasing area and the temperature increasing efficiency of the upper intake welding rib, the lower intake welding rib 61, the upper outlet welding rib, and the lower outlet welding rib 75.

As shown in FIGS. 1, 2, and 6, in the vehicle beam 10, the air A1 for air conditioning sent from the air conditioning system flows through the inflow path 52 in the intake duct portion 51 and is guided to the flow path 12 in the duct body portion 11. The air A1 flows through the flow path 12, then flows through the outlet flow path 66 in each outlet duct portion 65, and is then blown out to the rear side of the vehicle beam 10. The air A1 flows through the duct between the outlet duct portion 65 and the outlet port of the instrument panel 9, and then is blown out from the outlet port to a vehicle compartment.

As shown in FIGS. 1, 2, and 5, the upper duct divided body 15 and the lower duct divided body 30 are coupled by joining the upper front connection portion 16 and the lower front connection portion 31, joining the upper rear connection portion 21 and the lower rear connection portion 36, and joining the upper end connection portion 25 and the lower end connection portion 39. The duct body portion 11 is formed by the coupling.

The upper front connection portion 16 and the lower front connection portion 31 are joined by welding the upper front welding ribs 18 and the lower front welding ribs 33 located below the upper front welding ribs 18. The upper rear connection portion 21 and the lower rear connection portion 36 are joined by welding the upper rear welding ribs 23 and the lower rear welding ribs 38 located below the upper rear welding ribs 23. The upper end connection portion 25 and the lower end connection portion 39 adjacent to each other in the upper-lower direction are joined by welding the upper end welding ribs and the lower end welding ribs 42 located below the upper end welding ribs.

The upper front welding ribs 18 and the lower front welding ribs 33 each extend in the left-right direction. Accordingly, compared to a case where the upper front connection portion 16 and the lower front connection portion 31 are joined by fastening bolts arranged at a plurality of locations separated from each other in the left-right direction, the upper front connection portion 16 and the lower front connection portion 31 are joined over a wide region in the same direction. The sealing performance of the joint portion between the upper front connection portion 16 and the lower front connection portion 31 is improved as compared with the case where the joint is fastened with bolts.

Further, the upper rear welding ribs 23 and the lower rear welding ribs 38 each extend in the left-right direction. Accordingly, compared to a case where the upper rear connection portion 21 and the lower rear connection portion 36 are joined by fastening bolts arranged at a plurality of locations separated from each other in the left-right direction, the upper rear connection portion 21 and the lower rear connection portion 36 are joined over a wide region in the same direction. The sealing performance of the joint portion between the upper rear connection portion 21 and the lower rear connection portion 36 is improved as compared with the case where the joint is fastened with bolts.

The upper end welding ribs and the lower end welding ribs 42 that face each other in the upper-lower direction each extend in the front-rear direction. Accordingly, the upper end connection portion 25 and the lower end connection portion 39 are joined in a wide region in the front-rear direction. The sealing performance is ensured at the joint portion between the upper end connection portion 25 and the lower end connection portion 39 adjacent to each other in the upper-lower direction.

As shown in FIGS. 1 and 2, in the first embodiment, the upper intake duct divided body 53 and the lower intake duct divided body 57 are coupled by joining the upper intake connection portion 54 and the lower intake connection portion 58. The intake duct portion 51 is formed by the coupling. The upper intake connection portion 54 and the lower intake connection portion 58 are joined to each other by welding the upper intake welding ribs and the lower intake welding ribs 61 adjacent to each other in the upper-lower direction. Each of the upper intake welding ribs extends in the front-rear direction, and is connected to the upper front welding rib 18 (see FIG. 5) of the upper duct divided body 15 at the rear end portion thereof. Each of the lower intake welding ribs 61 extends in the front-rear direction, and is connected to the lower front welding rib 33 of the lower duct divided body 30 at the rear end portion thereof. Accordingly, the sealing performance of the joint portion between the upper intake connection portion 54 and the lower intake connection portion 58 is ensured.

Further, since the upper intake connection portion 54 and the lower intake connection portion 58 adjacent to each other in the upper-lower direction are joined by welding, the number of welded locations in the entire vehicle beam 10 increases.

Further, in the first embodiment, the upper outlet duct divided body 67 and the lower outlet duct divided body 72 are coupled to each other by joining the upper outlet connection portions 68 and the lower outlet connection portions 73. Each outlet duct portion 65 is formed by the coupling. The upper outlet connection portion 68 and the lower outlet connection portion 73 are joined by welding the upper outlet welding ribs and the lower outlet welding ribs 75. The upper outlet welding ribs extend in the front-rear direction and are connected to the upper rear welding ribs 23 (see FIG. 5) of the upper duct divided body 15 at the front end portions thereof. The lower outlet welding ribs 75 extend in the front-rear direction and are connected to the lower rear welding ribs 38 of the lower duct divided body 30 at the front end portions thereof. Accordingly, the sealing performance of the joint portion between the upper outlet connection portion 68 and the lower outlet connection portion 73 is ensured.

Further, since the upper outlet connection portion 68 and the lower outlet connection portion 73 are joined by welding, the number of welded locations in the entire vehicle beam 10 increases.

The steering column SC, which is disposed below the duct body portion 11 and the peripheral portion, is suspended from the peripheral portion on the front side of the duct body portion 11 and the peripheral portion on the rear side.

Here, if the duct body portion 11 is divided into two duct divided bodies in the front-rear direction, the steering column SC is suspended from a front peripheral portion connected to a front duct divided body in front of the duct body portion 11. Further, the steering column SC is suspended from a rear peripheral portion connected to a rear duct divided body on the rear side of the duct body portion 11. In this case, a load of the steering column SC is received by the front peripheral portion in front of the duct body portion 11. The load is received by the rear peripheral portion on the rear side of the duct body portion 11.

In contrast, in the first embodiment, as shown in FIGS. 3 and 4, the steering column SC is suspended from at least one of the upper front support portion 77 or the lower front support portion 82 in front of the duct body portion 11. The steering column SC is suspended from the upper rear support portion 78 and the lower rear support portion 83 in the rear side of the duct body portion 11. In this case, the load of the steering column SC is received by one or two front support portions in front of the duct body portion 11. Further, the load is received by two upper and lower rear support portions on the rear side of the duct body portion 11. Such a way of receiving the load can be achieved by dividing the duct body portion 11 into two upper and lower duct divided bodies (the upper duct divided body 15 and the lower duct divided body 30).

### Effects of First Embodiment

(1-1) As shown in FIG. 5, the upper front connection portion 16 and the lower front connection portion 31 are joined by welding the upper front welding ribs 18 and the lower front welding ribs 33 each extending in the left-right direction. Therefore, it is possible to improve the sealing performance of the joint portion between the upper front connection portion 16 and the lower front connection portion 31.

Further, the upper rear connection portion 21 and the lower rear connection portion 36 are joined by welding the upper rear welding ribs 23 and the lower rear welding ribs 38 each extending in the left-right direction. Therefore, it is possible to improve the sealing performance of the joint portion between the upper rear connection portion 21 and the lower rear connection portion 36.

Further, as shown in FIGS. 1 and 2, the upper end connection portion 25 and the lower end connection portion 39 adjacent to each other in the upper-lower direction are joined by welding the upper end welding ribs and the lower end welding ribs 42 located below the upper end welding ribs. Therefore, it is possible to improve the sealing performance of the joint portion between the upper end connection portion 25 and the lower end connection portion 39 adjacent to each other in the upper-lower direction.

As a result, the sealing performance of the entire duct body portion 11 can be improved, and the phenomenon in which the air A1 flowing through the flow path 12 leaks out from the joint portion between the adjacent connection portions can be reduced more effectively than in the case of joining by bolt fastening.

(1-2) When coupling the upper intake duct divided body 53 and the lower intake duct divided body 57 to form the intake duct portion 51, the upper intake connection portion 54 and the lower intake connection portion 58 are joined by welding the upper intake welding ribs and the lower intake welding ribs 61. The upper intake welding rib extends in the front-rear direction and is connected to the upper front welding rib 18 of the upper duct divided body 15 at the rear end portion thereof. The lower intake welding rib 61 extends in the front-rear direction and is connected to the lower front welding rib 33 of the lower duct divided body 30 at the rear end portion thereof.

Therefore, the sealing performance of the joint portion between the upper intake connection portion 54 and the lower intake connection portion 58 can be ensured, and the air A1 flowing through the inflow path 52 can be prevented from leaking to the outside of the vehicle beam 10 from the joint portion. Further, the number of welded locations can be increased by the amount of welding of the upper intake welding ribs and the lower intake welding ribs 61, thereby increasing the welding strength of the entire vehicle beam 10.

(1-3) The upper outlet connection portion 68 and the lower outlet connection portion 73 are joined by welding the upper outlet welding ribs and the lower outlet welding ribs 75. The upper outlet welding rib extends in the front-rear direction and is connected to the upper rear welding rib 23 of the upper duct divided body 15 at the front end portion thereof. The lower outlet welding rib 75 extends in the front-rear direction and is connected to the lower rear welding rib 38 of the lower duct divided body 30 at the front end portion thereof.

Therefore, the sealing performance of the joint portion between the upper outlet connection portion 68 and the lower outlet connection portion 73 can be ensured, and the air A1 flowing through the outlet flow path 66 can be prevented from leaking to the outside of the vehicle beam 10 from the joint portion. Further, the number of welded locations can be increased by the amount of welding of the upper outlet welding ribs and the lower outlet welding ribs 75, thereby increasing the welding strength of the entire vehicle beam 10.

(1-4) As shown in FIG. 3, the duct body portion 11 is divided into the upper duct divided body 15 and the lower duct divided body 30. The peripheral portion includes the upper support portion 76 having the upper front support portion 77 and the upper rear support portion 78, and the lower support portion 81 having the lower front support portion 82 and the lower rear support portion 83. At least one of the upper front support portion 77 or the lower front support portion 82 is provided with a portion where the steering column SC is suspended in front of the duct body portion 11. Each of the upper rear support portion 78 and the lower rear support portion 83 is provided with a portion where the steering column SC is suspended in the rear of the duct body portion 11. The steering column SC is suspended from the portion in front of the duct body portion 11 and is suspended from the portion in the rear of the duct body portion 11.

Therefore, compared to a case where the duct body portion 11 is divided into two front and rear duct divided bodies, it is advantageous in terms of receiving the load of the steering column SC.

(1-5) As shown in FIG. 5 and the like, since the duct body portion 11 has a circular cross section, the duct body portion 11 exhibits the same degree of high strength at any location in the circumferential direction. The duct body portion 11 exhibits high strength compared to a case where the duct body portion 11 has other cross-sectional shapes.

(1-6) Since the reinforcing ribs 84 and 85 are formed on the outer circumferential surface of the duct body portion 11, the strength and rigidity of the duct body portion 11 can be increased.

(1-7) The upper front welding ribs 18 are formed on the upper front facing surface 17, and the lower front welding ribs 33 are formed on the lower front facing surface 32. The upper front welding ribs 18 and the lower front welding ribs 33 face each other in the upper-lower direction. The upper front welding ribs 18 and the lower front welding ribs 33 are welded to each other, so that the upper front connection portion 16 and the lower front connection portion 31 are joined together.

Therefore, an area of a location that needs to be heated up can be reduced than in a case where the upper front welding ribs 18 are formed on the upper front facing surface 17 while the lower front welding ribs 33 are not formed on the lower front facing surface 32. Further, an area of a location that needs to be heated up can be reduced than in a case where the lower front welding ribs 33 are formed on the lower front facing surface 32 while the upper front welding ribs 18 are not formed on the upper front facing surface 17. As a result, heat dispersion can be reduced and the heating efficiency can be improved.

Similarly, the upper rear welding ribs 23 are formed on the upper rear facing surface 22, and the lower rear welding ribs 38 are formed on the lower rear facing surface 37. The upper rear welding ribs 23 and the lower rear welding ribs 38 face each other in the upper-lower direction. The upper rear welding ribs 23 and the lower rear welding ribs 38 are welded to each other, so that the upper rear connection portion 21 and the lower rear connection portion 36 are joined together.

Therefore, an area of a location that needs to be heated up can be reduced than in a case where the upper rear welding ribs 23 are formed on the upper rear facing surface 22 while the lower rear welding ribs 38 are not formed on the lower rear facing surface 37. Further, an area of a location that needs to be heated up can be reduced than in a case where the lower rear welding ribs 38 are formed on the lower rear facing surface 37 while the upper rear welding ribs 23 are not formed on the upper rear facing surface 22. As a result, heat dispersion can be reduced and the heating efficiency can be improved.

The above-described effect can be similarly obtained at the joint portion between the upper end connection portion 25 and the lower end connection portion 39, the joint portion between the upper intake connection portion 54 and the lower intake connection portion 58, and the joint portion between the upper outlet connection portion 68 and the lower outlet connection portion 73.

### Second Embodiment

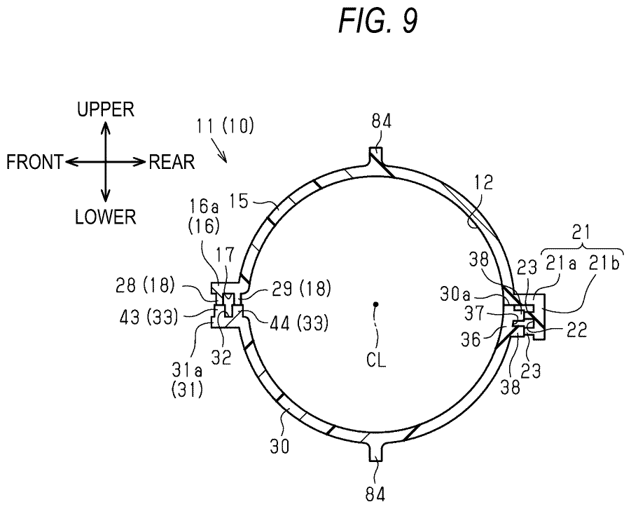

Next, a vehicle beam according to a second embodiment will be described with reference to FIGS. 9 to 11.

In the second embodiment, the shapes of the upper rear connection portion 21 and the lower rear connection portion 36 are different from those in the first embodiment. The upper rear connection portion 21 has a bent portion 21b that is bent downward from a rear end portion of the flange portion 21a. A front surface of the bent portion 21b serves as the upper rear facing surface 22 of the upper rear connection portion 21. The upper rear facing surface 22 extends in the upper-lower direction and the left-right direction and faces forward. In this regard, as described above, the upper front facing surface 17 of the upper front connection portion 16 extends in the front-rear direction and the left-right direction and faces downward. In this way, the upper rear facing surface 22 faces in a direction different from the direction in which the upper front facing surface 17 faces, and in the second embodiment, faces in a direction intersecting the direction in which the upper front facing surface 17 faces.

The lower rear connection portion 36 does not have the flange portion 36a. The lower rear connection portion 36 is formed by a portion of the lower duct divided body 30 adjacent to an upper surface 30a of a rear end portion on the lower side in the circumferential direction. An outer circumferential surface of the lower rear connection portion 36 serves as the lower rear facing surface 37. The lower rear facing surface 37 faces rearward. In this regard, as described above, the lower front facing surface 32 of the lower front connection portion 31 extends in the front-rear direction and the left-right direction and faces upward. In this way, the lower rear facing surface 37 faces in a direction different from a direction in which the lower front facing surface 32 faces, and in the second embodiment, faces in a direction intersecting the direction in which the lower front facing surface 32 faces.

The upper rear facing surface 22 is formed with two upper rear welding ribs 23 extending in a direction intersecting the direction in which the lower rear facing surface 37 and the upper rear facing surface 22 face each other. The lower rear facing surface 37 is formed with two lower rear welding ribs 38 extending in the intersecting direction. In the second embodiment, the two upper rear welding ribs 23 extend in the left-right direction while being spaced apart and parallel to each other in the upper-lower direction. Similarly, the lower rear welding ribs 38 extend in the left-right direction while being spaced apart and parallel to each other in the upper-lower direction.

The upper rear connection portion 21 and the lower rear connection portion 36 are joined by welding the upper rear welding ribs 23 and the lower rear welding ribs 38 facing each other in the front-rear direction. The configuration other than the above is the same as that of the first embodiment.

Therefore, the same elements as those described in the first embodiment are denoted by the same reference numerals, and redundant description thereof is omitted.

### Operations of Second Embodiment

In the second embodiment, the following operations are achieved in addition to the same operations as those of the first embodiment.

Before the welding of the upper front welding rib 18 and the lower front welding rib 33 as well as the welding of the upper rear welding rib 23 and the lower rear welding rib 38, the upper duct divided body 15 and the lower duct divided body 30 are brought close to each other, for example, in the upper-lower direction in which the upper front facing surface 17 and the lower front facing surface 32 face each other.

When the upper front welding ribs 18 and the lower front welding ribs 33 are brought into contact with each other, the upper duct divided body 15 and the lower duct divided body 30 are positioned in the upper-lower direction. Accordingly, the upper rear welding ribs 23 and the lower rear welding ribs 38 are positioned in the upper-lower direction. This positioning enables the upper rear welding ribs 23 and the lower rear welding ribs 38 to face each other in the front-rear direction.

Further, before the welding, the upper duct divided body 15 and the lower duct divided body 30 are brought close to each other, for example, in the front-rear direction in which the upper rear facing surface 22 and the lower rear facing surface 37 face each other. When the upper rear welding ribs 23 and the lower rear welding ribs 38 are brought into contact with each other, the upper duct divided body 15 and the lower duct divided body 30 are positioned in the front-rear direction. Accordingly, the upper front welding ribs 18 and the lower front welding ribs 33 are positioned in the front-rear direction. This positioning enables the upper front welding ribs 18 and the lower front welding ribs 33 to face each other in the upper-lower direction.

Then, the upper front welding ribs 18 and the lower front welding ribs 33 are welded together, and the upper rear welding ribs 23 and the lower rear welding ribs 38 are welded together. The upper front connection portion 16 and the lower front connection portion 31 are joined together by the former welding. The upper rear connection portion 21 and the lower rear connection portion 36 are joined together by the latter welding. The upper duct divided body 15 and the lower duct divided body 30 are coupled by the joining described above and the joining of the left and right upper end connection portions 25 and the left and right lower end connection portions 39 (see FIG. 1), thereby forming the duct body portion 11.

### Effects of Second Embodiment

According to the second embodiment, the following effects are obtained in addition to the same effects as (1-1) to (1-7) of the first embodiment.

(2-1) The upper rear facing surface 22 of the upper rear connection portion 21 in the upper duct divided body 15 faces in a direction intersecting the direction in which the upper front facing surface 17 of the upper front connection portion 16 faces. Further, the lower rear facing surface 37 of the lower rear connection portion 36 in the lower duct divided body 30 faces a direction intersecting the direction in which the lower front facing surface 32 of the lower front connection portion 31 faces.

Therefore, before the welding, the upper duct divided body 15 and the lower duct divided body 30 are brought close to each other in the front-rear direction, and the upper rear welding ribs 23 and the lower rear welding ribs 38 are brought into contact with each other, so that the upper front welding ribs 18 and the lower front welding ribs 33 can be positioned in the front-rear direction. The upper front welding ribs 18 and the lower front welding ribs 33 can be welded in a state of facing each other in the upper-lower direction. This makes it possible to prevent the upper front welding ribs 18 and the lower front welding ribs 33 from being welded in a state of being misaligned in the front-rear direction.

Further, before the welding, the upper duct divided body 15 and the lower duct divided body 30 are brought close to each other in the upper-lower direction, and the upper front welding ribs 18 and the lower front welding ribs 33 are brought into contact with each other, so that the upper rear welding ribs 23 and the lower rear welding ribs 38 can be positioned in the upper-lower direction. The upper rear welding ribs 23 and the lower rear welding ribs 38 can be welded in a state of facing each other in the front-rear direction. This makes it possible to prevent the upper rear welding ribs 23 and the lower rear welding ribs 38 from being welded in a state of being misaligned in the upper-lower direction.

### Third Embodiment

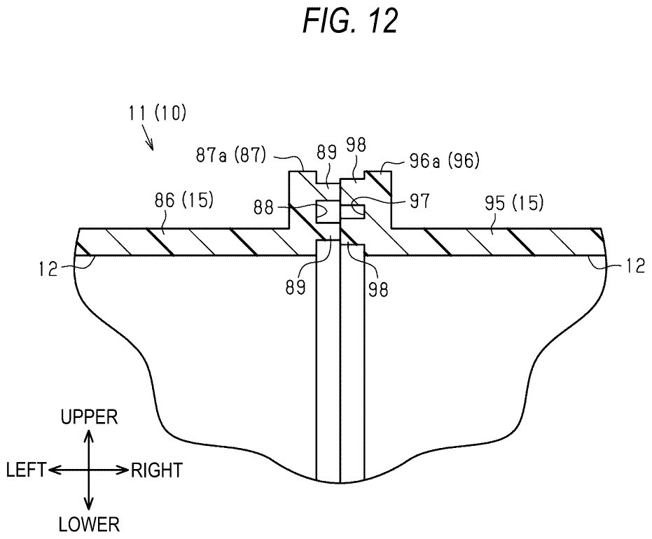

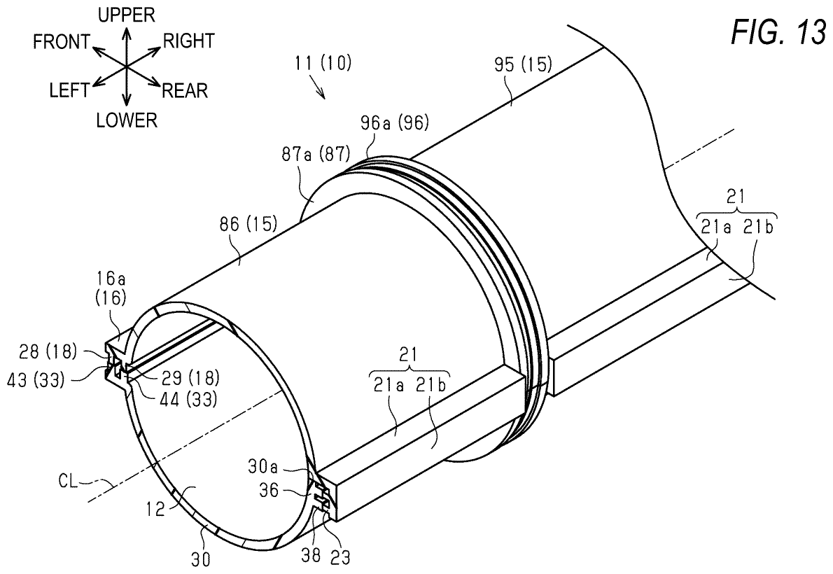

Next, a vehicle beam according to a third embodiment will be described with reference to FIGS. 12 and 13.

In the third embodiment, the duct body portion 11 formed by coupling the upper duct divided body 15 and the lower duct divided body 30 as described above is further divided into a plurality of duct body components in the left-right direction, and adjacent duct body components are coupled by welding. In this respect, the third embodiment is different from the first and second embodiments in which the duct body portion 11 is not divided in the left-right direction.

Here, of the two duct body components adjacent to each other in the left-right direction, one (left one in FIGS. 12 and 13) is referred to as a first duct body component 86, and the other (right one in FIGS. 12 and 13) is referred to as a second duct body component 95.

The first duct body component 86 is formed with a first auxiliary connection portion 87 at a boundary with the second duct body component 95. The first auxiliary connection portion 87 has an annular flange portion 87a protruding outward in the radial direction from an outer circumferential surface of the first duct body component 86. The second duct body component 95 is formed with a second auxiliary connection portion 96 at a boundary with the first duct body component 86. The second auxiliary connection portion 96 has an annular flange portion 96a protruding outward in the radial direction from an outer circumferential surface of the second duct body component 95.

The first duct body component 86 and the second duct body component 95 are coupled by joining the first auxiliary connection portion 87 and the second auxiliary connection portion 96.

The first auxiliary connection portion 87 has a first auxiliary facing surface 88 that is annular and surrounds the flow path 12. The second auxiliary connection portion 96 has a second auxiliary facing surface 97 that is annular and surrounds the flow path 12. The first auxiliary facing surface 88 and the second auxiliary facing surface 97 face each other in the left-right direction.

The first auxiliary facing surface 88 is formed with two annular first auxiliary welding ribs 89 having different diameters and centered on the central axis CL thereof. The second auxiliary facing surface 97 is formed with two annular second auxiliary welding ribs 98 having different diameters and centered on the central axis CL thereof. The first auxiliary connection portion 87 and the second auxiliary connection portion 96 are joined by welding the first auxiliary welding ribs 89 and the second auxiliary welding ribs 98 facing each other in the left-right direction.

The configuration other than the above is the same as that of the second embodiment. Therefore, the same elements as those described in the second embodiment are denoted by the same reference numerals, and redundant description thereof is omitted.

### Operations of Third Embodiment

A length of each of the first duct body component 86 and the second duct body component 95 which are formed by dividing the duct body portion 11 in the left-right direction is shorter than a length of the undivided duct body portion 11.

Further, the first duct body component 86 and second duct body component 95 adjacent to each other are joined together by welding the first auxiliary welding ribs 89 and the second auxiliary welding ribs 98 that face each other in the left-right direction. The first auxiliary welding ribs 89 and the second auxiliary welding ribs 98 each have an annular shape and surround the flow path 12. Therefore, the air A1 flowing through the flow path 12 is restricted by the first auxiliary welding ribs 89 and the second auxiliary welding ribs 98 from passing through the joint portion between the first auxiliary connection portion 87 and the second auxiliary connection portion 96.

### Effects of Third Embodiment

According to the third embodiment, in addition to the same effects as (1-1) to (1-7) of the first embodiment and (2-1) of the second embodiment, the following effects are obtained.

(3-1) As shown in FIG. 13, the first duct body component 86 and the second duct body component 95, which are shorter than the undivided duct body portion 11, are coupled by welding. Therefore, the following various effects are obtained.

The first duct body component 86 and the second duct body component 95 can be welded using a smaller welding facility, for example, an existing welding facility, compared to the case of welding the upper duct divided body 15 and the lower duct divided body 30 which are not divided in the left-right direction and are long in the same direction. Further, the first duct body component 86 and the second duct body component 95 are easier to weld with precision than the undivided duct body portion 11.

A part (for example, one) of the plurality of duct body components can be used for the vehicle beam 10 mounted on different types of vehicles 6, so that so-called part standardization can be achieved.

(3-2) As shown in FIG. 12, the annular first auxiliary welding ribs 89 are formed on the first auxiliary facing surface 88 of the first auxiliary connection portion 87, and the annular second auxiliary welding ribs 98 are formed on the second auxiliary facing surface 97 of the second auxiliary connection portion 96. The first auxiliary welding ribs 89 and the second auxiliary welding ribs 98 that face each other in the left-right direction are welded together, so that the first auxiliary connection portion 87 and the second auxiliary connection portion 96 are joined together.

Therefore, the sealing performance of the joint portion between the first auxiliary connection portion 87 and the second auxiliary connection portion 96 can be ensured, and the air A1 flowing through the duct body portion 11 can be prevented from leaking to the outside of the vehicle beam 10 from the joint portion.

### Fourth Embodiment

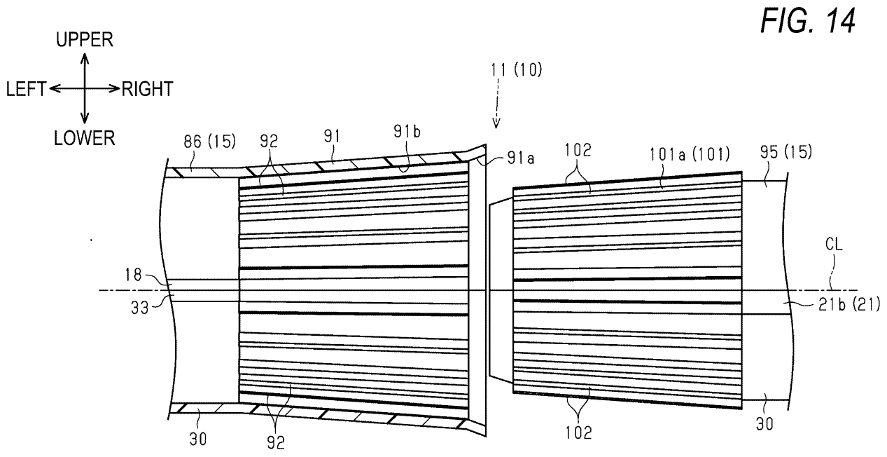

Next, a vehicle beam according to a fourth embodiment will be described with reference to FIG. 14.

In the fourth embodiment, the duct body portion 11 is divided into a plurality of duct body components in the left-right direction. Of the duct body components adjacent to each other, one (left one in FIG. 14) is referred to as the first duct body component 86, and the other (right one in FIG. 14) is referred to as the second duct body component 95. In this regard, the fourth embodiment is common to the third embodiment.

In the fourth embodiment, the first duct body component 86 has a cylindrical first tube portion 91 on one end portion (right end in FIG. 14) in the left-right direction. The second duct body component 95 has a cylindrical second tube portion 101 on one end portion (left end in FIG. 14) in the left-right direction.

The first tube portion 91 has an insertion opening 91a for the second tube portion 101 on one end surface (right end surface in FIG. 14) in the left-right direction. At least an inner surface (inner circumferential surface 91b) of the first tube portion 91 in the radial direction is formed as a tapered surface that increases in diameter as it approaches the insertion opening 91a along the central axis CL. At least an outer surface (outer circumferential surface 101a) of the second tube portion 101 in the radial direction is formed as a tapered surface that increases in diameter as it goes away from a tip end along the central axis CL. By inserting the entire second tube portion 101 into the first tube portion 91, the first tube portion 91 of the first duct body component 86 overlaps the second tube portion 101 of the second duct body component 95 in the radial direction.

A plurality of linear welding ribs 92 are formed on the inner circumferential surface 91b of the first tube portion 91 and extend substantially in the left-right direction along the inner circumferential surface 91b. The linear welding ribs 92 adjacent to each other are spaced apart from each other in the circumferential direction of the inner circumferential surface 91b. A plurality of linear welding ribs 102 are formed on the outer circumferential surface 101a of the second tube portion 101 at locations inward of the linear welding ribs 92 in the radial direction, and extend substantially in the left-right direction along the outer circumferential surface 101a. That is, the plurality of linear welding ribs 102 are formed on the outer circumferential surface 101a in a state of being spaced apart from each other in the circumferential direction. The first tube portion 91 and the second tube portion 101 are joined by welding the linear welding ribs 92 and the linear welding ribs 102. Through this joining, the first duct body component 86 and the second duct body component 95 are coupled to form the duct body portion 11.

Although not shown, in the second tube portion 101, the flange portion 16a of the upper front connection portion 16 and the flange portion 21a of the upper rear connection portion 21 both protrude inward in the radial direction. The flange portion 31a of the lower front connection portion 31 and the flange portion 36a of the lower rear connection portion 36 both protrude inward in the radial direction. Therefore, the upper front connection portion 16 and the lower front connection portion 31 are joined to each other inward in the radial direction than the outer circumferential surface 101a of the second tube portion 101. The upper rear connection portion 21 and the lower rear connection portion 36 are joined to each other inward in the radial direction than the outer circumferential surface 101a of the second tube portion 101.

The configuration other than the above is the same as that of the second embodiment. Therefore, the same elements as those described in the second embodiment are denoted by the same reference numerals, and redundant description thereof is omitted.

### Operations of Fourth Embodiment

When coupling the adjacent first duct body component 86 and second duct body component 95, the second tube portion 101 is inserted into the first tube portion 91. Thus, the first tube portion 91 of the first duct body component 86 overlaps the second tube portion 101 of the second duct body component 95 in the radial direction. The first tube portion 91 and the second tube portion 101 are joined to each other by welding the linear welding ribs 92 to the linear welding ribs 102 located inward in the radial direction of the linear welding ribs 92.

### Effects of Fourth Embodiment

According to the fourth embodiment, in addition to the same effects as (1-1) to (1-7) of the first embodiment and (2-1) of the second embodiment, the following effects are obtained.

(4-1) When forming the duct body portion 11, the second tube portion 101 having the linear welding ribs 102 formed on the outer circumferential surface 101a is inserted into the first tube portion 91 having the linear welding ribs 92 formed on the inner circumferential surface 91b. By welding the linear welding ribs 92 and the linear welding ribs 102, the first tube portion 91 and the second tube portion 101 are joined to each other, and the first duct body component 86 and the second duct body component 95 are coupled together.

Therefore, the first tube portion 91 and the second tube portion 101 overlap each other in the radial direction, so that the joint strength between the first duct body component 86 and the second duct body component 95 can be increased as compared with a case where the first tube portion 91 and the second tube portion 101 do not overlap. Further, since the first tube portion 91 and the second tube portion 101 are joined to each other by welding of the linear welding ribs 92 and 102, the joint strength can be further increased.

### Fifth Embodiment

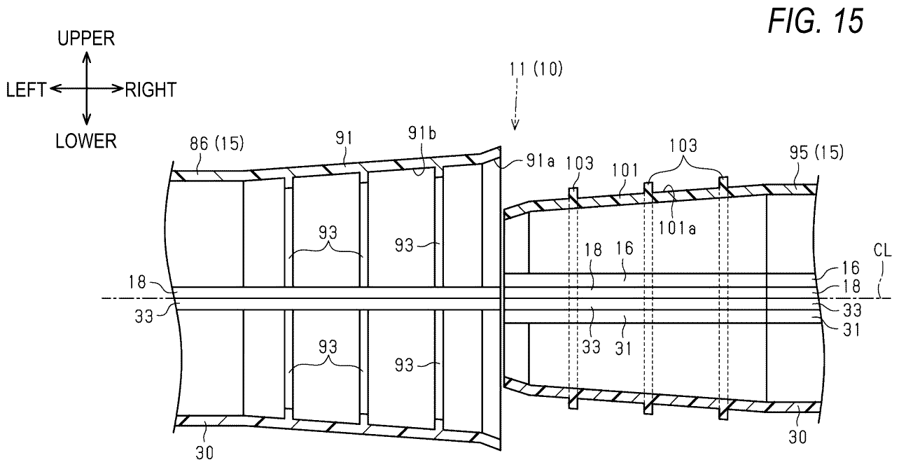

Next, a vehicle beam according to a fifth embodiment will be described with reference to FIG. 15.

In the fifth embodiment, the linear welding ribs 92 and 102 in the fourth embodiment are modified to annular welding ribs 93 and 103. More specifically, a plurality of annular welding ribs 93 are formed on the inner circumferential surface 91b of the first tube portion 91 and extend in the circumferential direction. Each annular welding rib 93 is formed over the entire circumference of the inner circumferential surface 91b and has an annular shape. The annular welding ribs 93 adjacent to each other are spaced apart from each other in the left-right direction. The annular welding ribs 103 are formed on the outer circumferential surface 101a of the second tube portion 101 at locations inward of the annular welding ribs 93 in the radial direction. That is, the plurality of annular welding ribs 103 are formed on the outer circumferential surface 101a of the second tube portion 101 in a state of being spaced apart from each other in the left-right direction. Each annular welding rib 103 is formed over the entire circumference of the outer circumferential surface 101a and has an annular shape.

The first tube portion 91 and the second tube portion 101 are joined by welding the annular welding ribs 93 and the annular welding ribs 103. Through this joining, the first duct body component 86 and the second duct body component 95 are coupled.

The fifth embodiment is common to the fourth embodiment in that the first tube portion 91 and the second tube portion 101 are joined by welding, although the shape of the welding rib is different. Therefore, according to the fifth embodiment, the same operations and effects as those of the fourth embodiment can be obtained.

### Sixth Embodiment

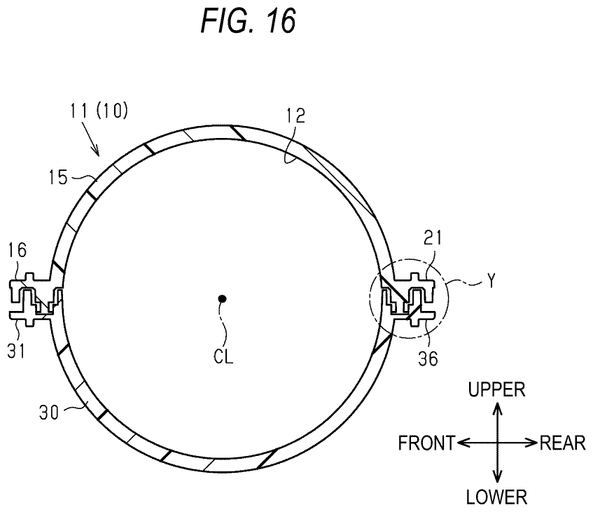

Next, a vehicle beam according to a sixth embodiment will be described with reference to FIGS. 16 to 18.

The sixth embodiment differs from the first embodiment mainly in the following two points.

The duct welding rib is formed on one of a pair of duct facing surfaces that face each other.

A trap rib is formed on the duct facing surface to trap burrs generated during welding between a pair of duct facing surfaces.

Next, the sixth embodiment will be described in detail focusing on the above difference.

As shown in FIG. 16, the upper front connection portion 16 and the lower front connection portion 31 are joined by welding. Further, the upper rear connection portion 21 and the lower rear connection portion 36 are joined by welding. A joining structure of the upper front connection portion 16 and the lower front connection portion 31 and a joining structure of the upper rear connection portion 21 and the lower rear connection portion 36 are in a plane-symmetrical relationship with respect to a plane that passes through the central axis CL and extends in the upper-lower direction. Therefore, here, the joining structure of the upper rear connection portion 21 and the lower rear connection portion 36 will be described, and description of the joining structure of the upper front connection portion 16 and the lower front connection portion 31 will be omitted.

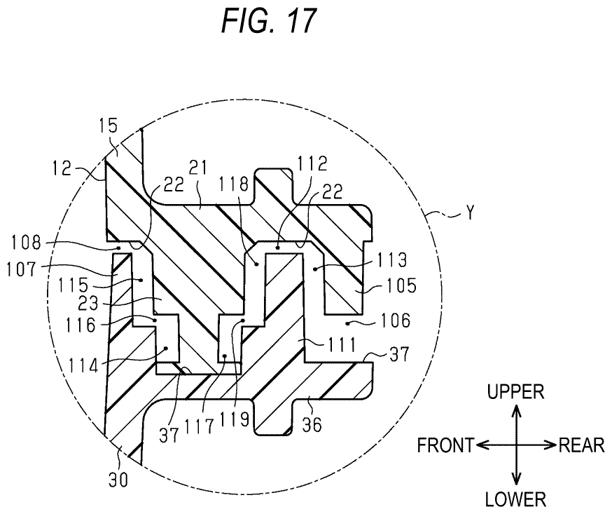

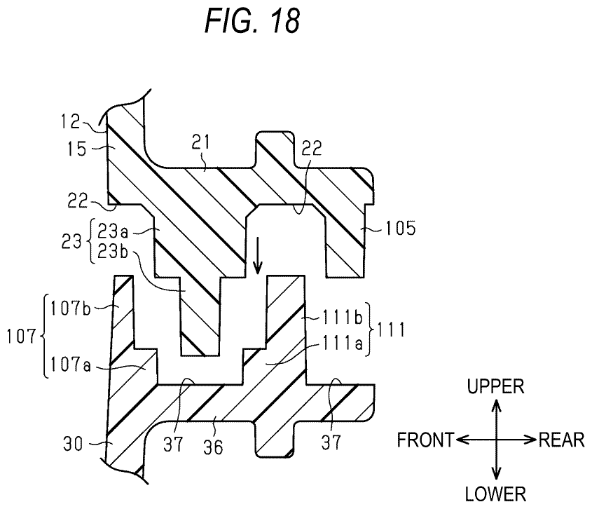

As shown in FIGS. 17 and 18, the upper rear connection portion 21 of the upper duct divided body 15 has the upper rear facing surface 22 which extends in the front-rear direction and the left-right direction on the lower surface thereof. The lower rear connection portion 36 of the lower duct divided body 30 has the lower rear facing surface 37 which extends in the front-rear direction and the left-right direction on the upper surface thereof.

One upper rear welding rib 23 is formed as the duct welding rib in a middle portion of the upper rear facing surface 22 in the front-rear direction. The upper rear welding rib 23 extends in the left-right direction while protruding downward from the upper rear facing surface 22. In the sixth embodiment, the upper rear welding rib 23 is formed in a front portion of the upper rear facing surface 22 at a location slightly separated rearward from a front end portion. In contrast, no lower rear welding rib is formed on the lower rear facing surface 37.

The upper rear welding rib 23 includes a welding base portion 23a located on a base end side (upper side) in a protruding direction of the upper rear welding rib 23, and a welding tip portion 23b adjacent to the welding base portion 23a on a tip end side (lower side) in the protruding direction.

The upper rear welding rib 23 is formed such that the dimension of the welding tip portion 23b in the front-rear direction is smaller than the dimension of the welding base portion 23a in the same direction. The front-rear direction is one of the radial directions of the duct body portion 11. The welding tip portion 23b is located at a middle portion of the welding base portion 23a in the front-rear direction.

A front surface of the welding tip portion 23b is located behind a front surface of the welding base portion 23a. The front surface of the welding base portion 23a and the front surface of the welding tip portion 23b are coupled to each other via a stepped surface, the stepped surface being a front lower surface of the welding base portion 23a.

A rear surface of the welding tip portion 23b is located in front of a rear surface of the welding base portion 23a. The rear surface of the welding base portion 23a and the rear surface of the welding tip portion 23b are coupled to each other via a rear lower surface of the welding base portion 23a.

At a rear end portion of the upper rear facing surface 22, one upper rear trap rib 105 extending in the left-right direction while protruding downward is formed as one of the plurality of trap ribs. The upper rear trap rib 105 is formed such that the dimension in the front-rear direction is substantially uniform in the upper-lower direction. The upper-lower direction is a direction in which the upper rear facing surface 22 and the lower rear facing surface 37 face each other.

A pair of lower rear trap ribs 107 and 111 are formed on the lower rear facing surface 37 as part of the plurality of trap ribs. The lower rear trap rib 107 is formed at a front end portion of the lower rear facing surface 37. The lower rear trap rib 111 is formed in a middle portion of the lower rear facing surface 37 in the front-rear direction. The lower rear trap ribs 107 and 111 both extend in the left-right direction while protruding upward.

As described above, a direction (left-right direction) in which the upper rear welding rib 23, the upper rear trap rib 105, and the lower rear trap ribs 107 and 111 extend is a direction along the upper rear facing surface 22 and the lower rear facing surface 37, and is a direction intersecting the upper-lower direction.

As described above, one upper rear trap rib 105 and two lower rear trap ribs 107 and 111 are formed between the upper rear facing surface 22 and the lower rear facing surface 37. Of these trap ribs, the lower rear trap rib 111 on the rear side and the upper rear trap rib 105 are formed on the upper rear facing surface 22 and the lower rear facing surface 37, respectively, at two locations spaced apart from each other in the front-rear direction.

The upper rear welding rib 23 and the lower rear trap rib 107 on the front side protrude in opposite directions along the upper-lower direction while being spaced apart from each other in the front-rear direction. Similarly, the upper rear welding rib 23 and the lower rear trap rib 111 on the rear side protrude in opposite directions along the upper-lower direction while being spaced apart from each other in the front-rear direction.

The lower rear trap rib 107 on the front side includes a trap base portion 107a located on the lower side, which is a base end side in a protruding direction of the lower rear trap rib 107, and a trap tip portion 107b adjacent to the upper side, which is a tip end side in the protruding direction, with respect to the trap base portion 107a.

The lower rear trap rib 107 on the front side is formed such that the dimension of the trap tip portion 107b in the front-rear direction is smaller than the dimension of the trap base portion 107a in the same direction. The trap tip portion 107b is located in a front portion of the trap base portion 107a.

A rear surface of the trap tip portion 107b is located forward of a rear surface of the trap base portion 107a. The rear surface of the trap base portion 107a and the rear surface of the trap tip portion 107b are coupled to each other via a stepped surface, the stepped surface being a rear upper surface of the trap base portion 107a.

Similarly, the lower rear trap rib 111 on the rear side includes a trap base portion 111a located on the lower side, which is a base end side in a protruding direction of the lower rear trap rib 111, and a trap tip portion 111b adjacent to the upper side, which is a front side in the protruding direction, with respect to the trap base portion 111a.

The lower rear trap rib 111 on the rear side is formed such that the dimension of the trap tip portion 111b in the front-rear direction is smaller than the dimension of the trap base portion 111a in the same direction. The trap tip portion 111b is located in a rear portion of the trap base portion 111a.

A front surface of the trap tip portion 111b is located behind a front surface of the trap base portion 111a. The front surface of the trap base portion 111a and the front surface of the trap tip portion 111b are coupled to each other via a stepped surface, the stepped surface being a front upper surface of the trap base portion 111a.

As shown in FIG. 17, a lower end portion, which is a tip end portion of the welding tip portion 23b, is welded to the lower rear facing surface 37. The upper rear connection portion 21 and the lower rear connection portion 36 are joined together by the welding. In a state where the upper rear connection portion 21 and the lower rear connection portion 36 are joined together, parts involved in the joint satisfy the following relationships.

The lower rear trap rib 107 on the front side is positioned at a location spaced forward, which is the inner side in the front-rear direction, from the upper rear trap rib 105. The lower rear trap rib 111 on the rear side is positioned at a location spaced forward from the upper rear trap rib 105, in the sixth embodiment, between the upper rear welding rib 23 and the upper rear trap rib 105.

The lower rear trap rib 111 on the rear side and the upper rear trap rib 105 are adjacent to each other in the front-rear direction and protrude in opposite directions along the upper-lower direction.

The upper rear trap rib 105 is spaced upward from the lower rear facing surface 37 via a gap 106.

The trap tip portion 107b of the lower rear trap rib 107 on the front side is spaced downward from the upper rear facing surface 22 via a gap 108. Similarly, the trap tip portion 111b of the lower rear trap rib 111 on the rear side is spaced downward from the upper rear facing surface 22 via a gap 112.

The lower rear trap rib 111 on the rear side and the upper rear trap rib 105 are spaced from each other in the front-rear direction via a gap 113.

The trap base portion 107a and the welding tip portion 23b are spaced apart from each other in the front-rear direction via a first gap 114 extending in the upper-lower direction. The welding base portion 23a and the trap tip portion 107b are spaced apart from each other in the front-rear direction via a second gap 115 extending in the upper-lower direction. The trap base portion 107a and the welding base portion 23a are spaced apart from each other in the upper-lower direction via a communication gap 116 that extends in the front-rear direction and communicates the first gap 114 and the second gap 115.

Similarly, the trap base portion 111a and the welding tip portion 23b are spaced apart from each other in the front-rear direction via a first gap 117 extending in the upper-lower direction. The welding base portion 23a and the trap tip portion 111b are spaced apart from each other in the front-rear direction via a second gap 118 extending in the upper-lower direction. The trap base portion 111a and the welding base portion 23a are spaced apart from each other in the upper-lower direction via a communication gap 119 that extends in the front-rear direction and communicates the first gap 117 and the second gap 118.

A part in the upper-lower direction of the lower rear trap rib 111 on the rear side and a part of the upper rear trap rib 105 in the same direction overlap each other in the upper-lower direction when viewed in the front-rear direction. The portion of the former includes an upper end portion, which is a tip end portion of the lower rear trap rib 111. The portion of the latter includes a lower end portion, which is a tip end portion of the upper rear trap rib 105.

Although not shown, the trap ribs described above are also provided at both end portions of the duct body portion 11 in the left-right direction, the intake duct portion 51, and the outlet duct portion 65 (see FIG. 1 and the like).

The configuration other than the above is the same as that of the first embodiment. Therefore, the same elements as those described in the first embodiment are denoted by the same reference numerals, and redundant description thereof is omitted.

### Operations of Sixth Embodiment

In the sixth embodiment, the following operations are achieved in addition to the same operations as those of the first embodiment.

In a case where a burr is generated when adjacent upper rear connection portion 21 and lower rear connection portion 36 are welded at the upper rear welding rib 23, if a structure for restricting movement of the burr is not provided, there is a risk that the burr may come out from between the upper rear facing surface 22 and the lower rear facing surface 37.

In this regard, in the sixth embodiment, the phenomenon in which the burr moves between the upper rear facing surface 22 and the lower rear facing surface 37 is restricted by the upper rear trap rib 105 and the lower rear trap ribs 107 and 111 provided at locations spaced apart from the upper rear welding rib 23 in the front-rear direction.

More specifically, when the burr moves forward from between the upper rear facing surface 22 and the lower rear facing surface 37, the burr moves through the first gap 114, the communication gap 116, the second gap 115, and the gap 108 in this order.

The burr comes into contact with the welding base portion 23a when moving upward through the first gap 114. The welding base portion 23a serves as a wall to restrict the upward movement of the burr, thereby attempting to capture the burr. A burr that is not captured by the welding base portion 23a changes a movement direction from upward to forward.

The burr whose movement direction is changed comes into contact with the trap tip portion 107b when moving forward through the communication gap 116. The trap tip portion 107b serves as a wall to restrict the forward movement of the burr, thereby attempting to capture the burr. A burr that is not captured by the trap tip portion 107b changes the movement direction from forward to upward.

The burr whose movement direction is changed comes into contact with the upper rear facing surface 22 when moving upward through the second gap 115. The upper rear facing surface 22 serves as a wall to restrict the upward movement of the burr, thereby attempting to capture the burr. A burr that is not captured by the upper rear facing surface 22 changes a movement direction from upward to forward. The burr whose movement direction is changed moves forward through the gap 108.

In this way, the number of times that movement of the burrs is restricted by the walls increases, and accordingly, the opportunity to capture the burrs is increased. An amount of burrs captured between the upper rear facing surface 22 and the lower rear facing surface 37 increases.

Similarly, when a burr moves rearward from between the upper rear facing surface 22 and the lower rear facing surface 37, the burr moves through the first gap 117, the communication gap 119, the second gap 118, the gap 112, the gap 113, and the gap 106 in this order.

The burr comes into contact with the welding base portion 23a when moving upward through the first gap 117. The welding base portion 23a serves as a wall to restrict the upward movement of the burr, thereby attempting to capture the burr. A burr that is not captured by the welding base portion 23a changes a movement direction from upward to rearward.

The burr whose movement direction is changed comes into contact with the trap tip portion 111b when moving rearward through the communication gap 119. The trap tip portion 111b serves as a wall to restrict the rearward movement of the burr, thereby attempting to capture the burr. A burr that is not captured by the trap tip portion 111b changes the movement direction from rearward to upward.

The burr whose movement direction is changed comes into contact with the upper rear facing surface 22 when moving upward through the second gap 118. The upper rear facing surface 22 serves as a wall to restrict the upward movement of the burr, thereby attempting to capture the burr. A burr that is not captured by the upper rear facing surface 22 changes a movement direction from upward to rearward.

The burr whose movement direction is changed comes into contact with the upper rear trap rib 105 when moving rearward through the gap 112. The upper rear trap rib 105 serves as a wall to restrict the rearward movement of the burr, thereby attempting to capture the burr. A burr that is not captured by the upper rear trap rib 105 changes the movement direction from rearward to downward.

The burr whose movement direction is changed comes into contact with the lower rear facing surface 37 when moving downward through the gap 113. The lower rear facing surface 37 serves as a wall to restrict the downward movement of the burr, thereby attempting to capture the burr. A burr that is not captured by the lower rear facing surface 37 changes a movement direction from downward to rearward.

In this way, the number of times that movement of the burrs is restricted by the walls increases, and accordingly, the opportunity to capture the burrs is increased. An amount of burrs captured between the upper rear facing surface 22 and the lower rear facing surface 37 increases.

The first gaps 114 and 117, the second gaps 115 and 118, and the communication gaps 116 and 119 each function as a space that traps the burrs. A total volume of the first gaps 114 and 117, the communication gaps 116 and 119, and the second gaps 115 and 118 is larger than a total volume when the first gaps 114 and 117 and the second gaps 115 and 118 are directly connected without the communication gaps 116 and 119. Therefore, it is possible to trap more burrs.

Moreover, the upper rear trap rib 105 and the lower rear trap rib 111 extend along the upper rear facing surface 22 and the lower rear facing surface 37 in a direction (left-right direction) intersecting the upper-lower direction. Therefore, the upper rear trap rib 105 and the lower rear trap rib 111 capture burrs in a wide region in the intersecting direction (left-right direction). In this way, a phenomenon that burrs come out from between the upper rear facing surface 22 and the lower rear facing surface 37 is reduced.

In particular, in the sixth embodiment, a part of the upper rear trap rib 105 formed on the upper rear facing surface 22 and a part of the lower rear trap rib 111 formed on the lower rear facing surface 37 overlap in the upper-lower direction when viewed in the front-rear direction. Therefore, as compared with a case where such a configuration is not provided, the number of times that movement of the burrs is restricted by the walls is increased.

Case where the above configuration is not provided include a case where the upper rear trap rib 105 and the lower rear trap rib 111 do not overlap each other, and a case where the trap rib is formed only on one of the upper rear facing surface 22 and the lower rear facing surface 37.

The number of times that movement of the burrs is restricted by the walls increases by restricting the movement of the burrs from the gap 112 to the gap 113 and restricting the movement of the burrs from the gap 113 to the gap 106.

The gap 113 at the part where the upper rear trap rib 105 and the lower rear trap rib 111 overlap each other functions as a space for capturing the burrs.

Therefore, a burr attempting to pass through the overlapping upper rear trap rib 105 and the lower rear trap rib 111 is likely to be captured by the gap 113 in the middle of the passage, and the number of locations where the burrs can be captured increases accordingly. The phenomenon that burrs come out from between the upper rear facing surface 22 and the lower rear facing surface 37 is further reduced.

As described above, the lower rear trap rib 107 on the front side restricts the burr from moving forward of the upper rear welding rib 23 between the upper rear facing surface 22 and the lower rear facing surface 37. Therefore, a phenomenon of a burr getting into the duct body portion 11 is restricted by the lower rear trap rib 107.

### Effects of Sixth Embodiment

According to the sixth embodiment, the following effects are obtained in addition to the same effects as (1-1) to (1-6) of the first embodiment.

(6-1) The upper rear trap rib 105 and the lower rear trap ribs 107 and 111 are formed on the upper rear facing surface 22 and the lower rear facing surface 37 at locations spaced apart from the upper rear welding rib 23 in the front-rear direction. The upper rear trap rib 105 and the lower rear trap ribs 107 and 111 extend in the left-right direction.

Therefore, even if a burr occurs during welding, the burr is trapped between the upper rear facing surface 22 and the lower rear facing surface 37, so that it is possible to prevent the burr from coming out from between the upper rear facing surface 22 and the lower rear facing surface 37.

(6-2) The lower rear trap rib 107 is formed on the front side, which is the inner side in the radial direction of the duct body portion 11, of the upper rear welding rib 23.

Therefore, after the burr moves forward between the upper rear facing surface 22 and the lower rear facing surface 37, the burr can be restricted from entering the duct body portion 11 and being carried to the vehicle compartment by the air A1 flowing through the flow path 12.

(6-3) The lower rear trap rib 111 and the upper rear trap rib 105 are formed on the upper rear facing surface 22 and the lower rear facing surface 37, respectively, at two locations spaced apart from each other in the front-rear direction. The lower rear trap rib 111 and the upper rear trap rib 105 are adjacent to each other in the front-rear direction and protrude in opposite directions along the upper-lower direction. A part of the lower rear trap rib 111 and a part of the upper rear trap rib 105 overlap in the upper-lower direction when viewed from the front-rear direction.

Therefore, by increasing the number of times that movement of the burrs is restricted by the walls, the opportunity to capture the burr can be increased. Further, the space for capturing the burr can be enlarged by the gap 113 formed by the overlapping. As a result, the burrs can be further prevented from coming out from between the upper rear facing surface 22 and the lower rear facing surface 37.

(6-4) The upper rear welding rib 23 including the welding base portion 23a and the welding tip portion 23b and the lower rear trap rib 107 including the trap base portion 107a and the trap tip portion 107b protrude in opposite directions along the upper-lower direction while being spaced apart from each other in the front-rear direction.

The upper rear welding rib 23 is configured such that the dimension of the welding tip portion 23b in the front-rear direction is smaller than the dimension of the welding base portion 23a in the same direction. The lower rear trap rib 107 is configured such that the dimension of the trap tip portion 107b in the front-rear direction is smaller than the dimension of the trap base portion 107a in the same direction. The rear surface of the trap tip portion 107b is located forward of the rear surface of the trap base portion 107a. The front surface of the welding tip portion 23b is located behind the front surface of the welding base portion 23a.

The trap base portion 107a and the welding tip portion 23b are spaced apart from each other in the front-rear direction via the first gap 114 extending in the upper-lower direction. The welding base portion 23a and the trap tip portion 107b are spaced apart from each other in the front-rear direction via the second gap 115 extending in the upper-lower direction. The trap base portion 107a and the welding base portion 23a are spaced apart from each other in the upper-lower direction via the communication gap 116 that extends in the front-rear direction and communicates the first gap 114 and the second gap 115.

Therefore, when the burr moves between the upper rear welding rib 23 and the lower rear trap rib 107, by increasing the number of times that movement of the burrs is restricted by the walls, the opportunity to capture the burrs can be increased. As a result, the burrs can be further prevented from moving forward from between the upper rear facing surface 22 and the lower rear facing surface 37.

Further, the space for trapping the burrs can be enlarged. Even if the amount of burrs generated varies, the burrs can be trapped between the upper rear facing surface 22 and the lower rear facing surface 37. In this respect, it is also possible to improve the performance of preventing the burrs from moving forward from between the upper rear facing surface 22 and the lower rear facing surface 37.

(6-5) In relation to (6-4), the upper rear welding rib 23 and the lower rear trap rib 111 including the trap base portion 111a and the trap tip portion 111b protrude in opposite directions along the upper-lower direction while being spaced apart from each other in the front-rear direction.

The lower rear trap rib 111 is configured such that the dimension of the trap tip portion 111b in the front-rear direction is smaller than the dimension of the trap base portion 111a in the same direction. The front surface of the trap tip portion 111b is located behind the front surface of the trap base portion 111a. The rear surface of the welding tip portion 23b is located in front of the rear surface of the welding base portion 23a.

The welding tip portion 23b and the trap base portion 111a are spaced apart from each other in the front-rear direction via the first gap 117 extending in the upper-lower direction. The welding base portion 23a and the trap tip portion 111b are spaced apart from each other in the front-rear direction via the second gap 118 extending in the upper-lower direction. The trap base portion 111a and the welding base portion 23a are spaced apart from each other in the upper-lower direction via the communication gap 119 that extends in the front-rear direction and communicates the first gap 117 and the second gap 118.

Therefore, when the burr moves between the upper rear welding rib 23 and the lower rear trap rib 111, by increasing the number of times that movement of the burrs is restricted by the walls, the opportunity to capture the burrs can be increased. As a result, the burrs can be further prevented from moving rearward from between the upper rear facing surface 22 and the lower rear facing surface 37.

Further, the space for trapping the burrs can be enlarged. Even if the amount of burrs generated varies, the burrs can be trapped between the upper rear facing surface 22 and the lower rear facing surface 37. In this respect, it is also possible to improve the performance of preventing the burrs from moving rearward from between the upper rear facing surface 22 and the lower rear facing surface 37.

### Seventh Embodiment

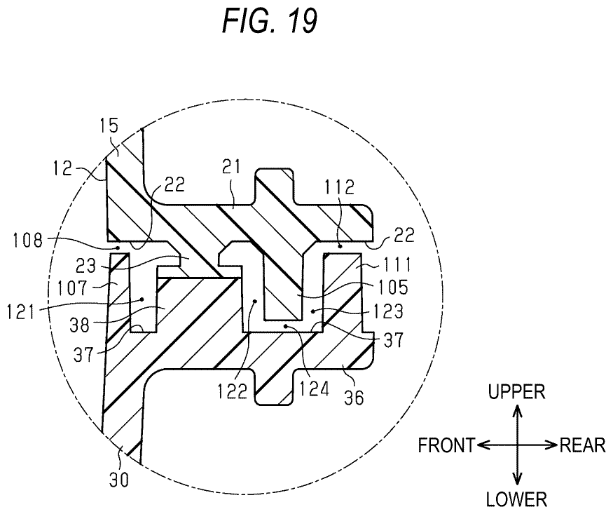

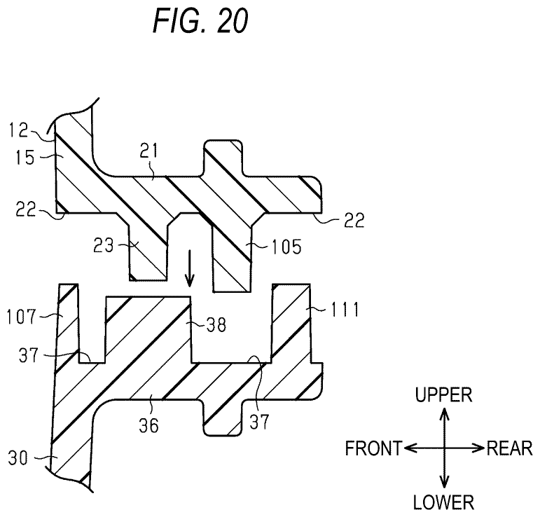

Next, a vehicle beam according to a seventh embodiment will be described with reference to FIGS. 19 and 20.

The seventh embodiment differs from the sixth embodiment mainly in the following point.

The duct welding rib is formed on both of a pair of duct facing surfaces that face each other.

Next, the seventh embodiment will be described in detail focusing on the above difference.

Here, similarly to the sixth embodiment, a joining structure by welding the upper rear connection portion 21 and the lower rear connection portion 36 will be described. In this joining structure, as shown in FIG. 20, the duct facing surfaces include the upper rear facing surface 22 of the upper rear connection portion 21 and the lower rear facing surface 37 of the lower rear connection portion 36.

Most of the upper rear welding rib 23 protruding downward from the upper rear facing surface 22, except for an upper end portion thereof, is formed such that the dimension in the front-rear direction is uniform in the upper-lower direction.

A lower rear welding rib 38 is formed on the lower rear facing surface 37 at a location below the upper rear welding rib 23. The lower rear welding rib 38 extends in the left-right direction while protruding upward from the lower rear facing surface 37. The lower rear welding rib 38 is formed to have a larger dimension in the front-rear direction than the upper rear welding rib 23. The lower rear welding rib 38 is formed such that the dimension in the front-rear direction is uniform in the upper-lower direction.

The upper rear trap rib 105 is formed on the upper rear facing surface 22 at a location spaced rearward from the upper rear welding rib 23 and in front of a rear end of the upper rear facing surface 22.

The lower rear trap rib 107 on the front side protrudes upward from a front end portion of the lower rear facing surface 37. The lower rear trap rib 107 is formed such that the dimension in the front-rear direction is substantially uniform in the upper-lower direction.

The lower rear trap rib 111 on the rear side is formed at a substantially rear end portion of the lower rear facing surface 37. The lower rear trap rib 111 is formed such that the dimension in the front-rear direction is uniform in the upper-lower direction.

As shown in FIG. 19, a lower end portion which is a tip end portion of the upper rear welding rib 23 is welded to an upper end portion which is a tip end portion of the lower rear welding rib 38. The upper rear connection portion 21 and the lower rear connection portion 36 are joined together by the welding. In a state where the upper rear connection portion 21 and the lower rear connection portion 36 are joined to each other, parts between the upper rear facing surface 22 and the lower rear facing surface 37 satisfy the following relationships.

The lower rear trap rib 111 on the rear side is spaced rearward from the upper rear trap rib 105.

The lower rear trap rib 107 on the front side and the upper rear facing surface 22 are spaced apart from each other in the upper-lower direction via the gap 108 extending in the front-rear direction. The lower rear trap rib 107 is spaced apart from the upper rear welding rib 23 and the lower rear welding rib 38 in the front-rear direction via a gap 121 extending in the upper-lower direction. The upper rear welding rib 23 and the lower rear welding rib 38 are spaced apart from the upper rear trap rib 105 in the front-rear direction via a gap 122 extending in the upper-lower direction. The upper rear trap rib 105 and the lower rear facing surface 37 are spaced apart from each other in the upper-lower direction via a gap 124 extending in the front-rear direction. The upper rear trap rib 105 and the lower rear trap rib 111 are spaced apart from each other in the front-rear direction via a gap 123 extending in the upper-lower direction. The lower rear trap rib 111 and the upper rear facing surface 22 are spaced apart from each other in the upper-lower direction via a gap 112 extending in the front-rear direction.

The configuration other than the above is the same as that of the sixth embodiment. Therefore, the same elements as those described in the sixth embodiment are denoted by the same reference numerals, and redundant description thereof is omitted.

### Operations of Seventh Embodiment

In the seventh embodiment, the following operations are achieved in addition to the same operations as those in the first and sixth embodiments.

In the seventh embodiment, the upper rear welding rib 23 formed on the upper rear facing surface 22 and the lower rear welding rib 38 formed on the lower rear facing surface 37 face each other in the upper-lower direction. The upper rear welding rib 23 and the lower rear welding rib 38 are welded to each other. During the welding, tip end surfaces of the upper rear welding rib 23 and the lower rear welding rib 38 are heated up. An area of each tip end surface that needs to be heated up is small. Therefore, heat is less likely to dissipate, and the efficiency of temperature rise is increased.

When a burr generated by the welding moves forward from between the upper rear facing surface 22 and the lower rear facing surface 37, the burr moves through the gap 121 and the gap 108 in this order. The burr comes into contact with the upper rear facing surface 22 when moving upward through the gap 121. The upper rear facing surface 22 serves as a wall to restrict the upward movement of the burr, thereby attempting to capture the burr. A burr that is not captured by the upper rear facing surface 22 changes a movement direction from upward to forward. In this way, the movement of the burr is restricted by the wall. Therefore, the burr moving forward between the upper rear facing surface 22 and the lower rear facing surface 37 is likely to be captured during the movement. As a result, a phenomenon in which the burr enters the duct body portion 11 and is carried to the vehicle compartment by the air A1 flowing through the flow path 12 is restricted.

Further, when a burr moves rearward from between the upper rear facing surface 22 and the lower rear facing surface 37, the burr moves through the gap 122, the gap 124, the gap 123, and the gap 112 in this order.

The burr comes into contact with the lower rear facing surface 37 moving downward through the gap 122. The lower rear facing surface 37 serves as a wall to restrict the downward movement of the burr, thereby attempting to capture the burr. A burr that is not captured by the lower rear facing surface 37 changes a movement direction from downward to rearward.

The burr whose movement direction is changed comes into contact with the lower rear trap rib 111 when moving rearward through the gap 124. The lower rear trap rib 111 serves as a wall to restrict the rearward movement of the burr, thereby attempting to capture the burr. A burr that is not captured by the lower rear trap rib 111 changes the movement direction from rearward to upward.

The burr whose movement direction is changed comes into contact with the upper rear facing surface 22 when moving upward through the gap 123. The upper rear facing surface 22 serves as a wall to restrict the upward movement of the burr, thereby attempting to capture the burr. A burr that is not captured by the upper rear facing surface 22 changes a movement direction from upward to rearward. The burr moves rearward through the gap 112.

In this way, the number of times that movement of the burrs is restricted by the walls increases, and accordingly, the opportunity to capture the burrs is increased. Therefore, an amount of burrs captured between the upper rear facing surface 22 and the lower rear facing surface 37 increases. The gap 122, the gap 124, and the gap 123 function as spaces for trapping burrs.

In the seventh embodiment, a part of the upper rear trap rib 105 that protrudes downward from the upper rear facing surface 22 and a part of the lower rear trap rib 111 that protrudes upward from the lower rear facing surface 37 overlap in the upper-lower direction when viewed in the front-rear direction. Therefore, as compared with a case where such a configuration is not provided, the number of times that movement of the burrs is restricted by the walls is increased. The number of times is increased by restricting the movement of the burrs from the gap 124 to the gap 123 and restricting the movement of the burrs from the gap 123 to the gap 112.

As described above, the gap 123 formed by the overlapping of the lower rear trap rib 111 and the upper rear trap rib 105 functions as a space for capturing the burrs.

Therefore, burrs attempting to pass rearward between the upper rear facing surface 22 and the lower rear facing surface 37 are more likely to be captured during the passage. The phenomenon that burrs come out rearward from between the upper rear facing surface 22 and the lower rear facing surface 37 is further reduced.

### Effects of Seventh Embodiment

According to the seventh embodiment, the same effects as (1-1) to (1-7) in the first embodiment and (6-1) to (6-3) in the sixth embodiment can be obtained.

### Eighth Embodiment

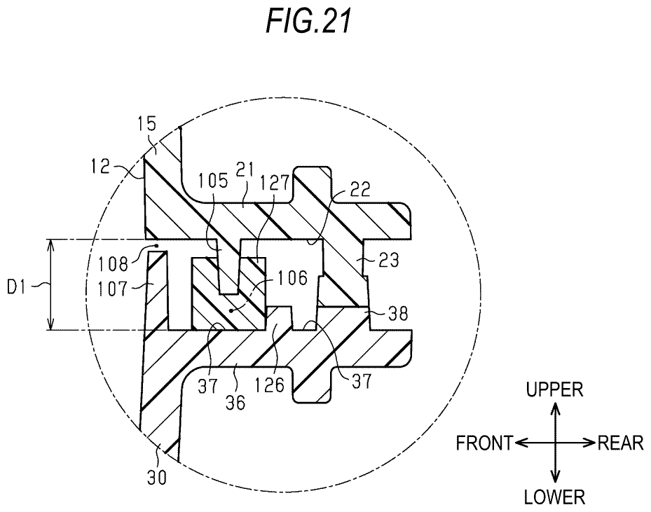

Next, a vehicle beam according to an eighth embodiment will be described with reference to FIGS. 21 to 23.

The eighth embodiment differs from the sixth embodiment mainly in the following point.

The duct welding rib is formed on both of a pair of duct facing surfaces that face each other.

A gap between a specific trap rib and the duct facing surface located on the front side in a protruding direction of the trap rib is filled with a trap reinforcement portion made of a material softer than the trap rib.

Next, the eighth embodiment will be described in detail focusing on the above difference.

Here, similarly to the sixth embodiment, a joining structure by welding the upper rear connection portion 21 and the lower rear connection portion 36 will be described. In this joining structure, the duct facing surfaces include the upper rear facing surface 22 of the upper rear connection portion 21 and the lower rear facing surface 37 of the lower rear connection portion 36. The duct welding ribs include the upper rear welding rib 23 and the lower rear welding rib 38. The trap ribs include the upper rear trap rib 105 and the lower rear trap rib 107.

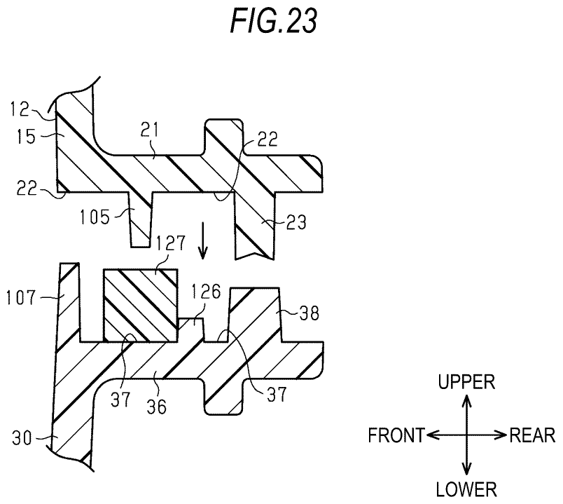

As shown in FIG. 23, the upper rear welding rib 23 is formed at a middle portion of the upper rear facing surface 22 in the front-rear direction, in the eighth embodiment, at a location spaced rearward from a central portion in the same direction. The upper rear welding rib 23 is formed such that the dimension in the front-rear direction is substantially uniform in the upper-lower direction.

The lower rear welding rib 38 is formed at a middle portion of the lower rear facing surface 37 in the front-rear direction, in the eighth embodiment, at a location spaced rearward from a central portion in the same direction. The lower rear welding rib 38 is formed to have a slightly larger dimension in the front-rear direction than the upper rear welding rib 23. The lower rear welding rib 38 is formed such that the dimension in the front-rear direction is substantially uniform in the upper-lower direction.

The upper rear trap rib 105 is formed at an intermediate location between a front end of the upper rear facing surface 22 and the upper rear welding rib 23. The upper rear trap rib 105 protrudes from the upper rear facing surface 22 toward the lower rear facing surface 37.

The lower rear trap rib 107 is formed at the front end portion of the lower rear facing surface 37.

A positioning rib 126 is formed on the lower rear facing surface 37 at a location rearward of the lower rear trap rib 107 and spaced forward from the lower rear welding rib 38. The positioning rib 126 extends in the left-right direction while protruding upward from the lower rear facing surface 37.

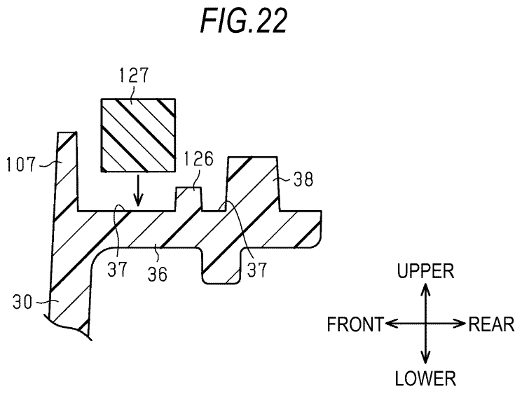

As shown in FIG. 22, a trap reinforcement portion 127 extending in the left-right direction is disposed on the lower rear facing surface 37. The trap reinforcement portion 127 is formed of a material that is softer than the upper rear trap rib 105, for example, urethane. The trap reinforcement portion 127 has a rectangular cross-sectional shape in the eighth embodiment, but may have a cross-sectional shape other than rectangular. The cross-sectional shape of the trap reinforcement portion 127 in the left-right direction is uniform in the left-right direction.

As shown in FIGS. 22 and 23, the trap reinforcement portion 127 is attached to the lower rear connection portion 36 before the upper rear connection portion 21 and the lower rear connection portion 36 are joined by welding. During the attachment, the trap reinforcement portion 127 is brought into contact with the positioning rib 126 and positioned in front of the positioning rib 126. The trap reinforcement portion 127 positioned in this manner is attached to the lower rear connection portion 36 by being attached to the lower rear facing surface 37 with a double-sided tape, an adhesive, or the like.

The lower end portion which is the tip end portion of the upper rear welding rib 23 is welded to the upper end portion which is the tip end portion of the lower rear welding rib 38. During the welding, as shown in FIG. 23, one of the upper rear connection portion 21 and the lower rear connection portion 36 is brought close to the other. In FIG. 23, the upper rear connection portion 21 is moved downward to approach the lower rear connection portion 36. During the approaching process, as shown in FIG. 21, at least a region including the lower end portion, which is the tip end portion in the protruding direction, of the upper rear trap rib 105 enters the trap reinforcement portion 127 from above. The trap reinforcement portion 127 is deformed by an external force applied in association with the entrance. The region of the upper rear trap rib 105 comes into close contact with the deformed location of the trap reinforcement portion 127. In this state, the upper rear welding rib 23 and the lower rear welding rib 38 are welded.

In a state where the upper rear connection portion 21 and the lower rear connection portion 36 are joined to each other by the welding, parts between the upper rear facing surface 22 and the lower rear facing surface 37 satisfy the following relationships.

The upper rear trap rib 105 is spaced upward from the lower rear facing surface 37 via a gap 106.

The lower rear trap rib 107 is spaced downward from the upper rear facing surface 22 via the gap 108.

The positioning rib 126 is located at a location rearward of the upper rear trap rib 105.

A distance between the upper rear facing surface 22 and the lower rear facing surface 37 is defined as a joint surface distance D1. The dimension of the trap reinforcement portion 127 in the upper-lower direction is set to be larger than a value obtained by subtracting the dimension of the upper rear trap rib 105 in the same direction from the joint surface distance D1.

### Operations of Eighth Embodiment

In the eighth embodiment, the following operations are achieved in addition to the same operations as those of the sixth embodiment.

Between the trap reinforcement portion 127 and the portion of the upper rear trap rib 105 that has entered the trap reinforcement portion 127, there is no gap or the gap is extremely small. Further, the gap 106 is filled with the trap reinforcement portion 127. Therefore, the burr is less likely to pass through the gap 106 than when the trap reinforcement portion 127 is not provided. As a result, the burr does not or hardly move forward from between the upper rear facing surface 22 and the lower rear facing surface 37.

### Effects of Eighth Embodiment

According to the eighth embodiment, in addition to the same effects as (1-1) to (1-7) of the first embodiment and (6-1) and (6-2) of the sixth embodiment, the following effects are obtained.

(8-1) The trap reinforcement portion 127 made of a material softer than the upper rear trap rib 105 is attached to the lower rear facing surface 37 on the front side in the protruding direction of the upper rear trap rib 105. At least the tip end portion of the upper rear trap rib 105 in the protruding direction enters the trap reinforcement portion 127. The trap reinforcement portion 127 fills the gap 106 between the upper rear trap rib 105 and the lower rear facing surface 37.

Between the trap reinforcement portion 127 and the portion of the upper rear trap rib 105 that has entered the trap reinforcement portion 127, there is no gap or the gap is extremely small. The trap reinforcement portion 127 can improve the performance of the upper rear trap rib 105 in capturing burrs. It is possible to prevent or almost prevent burrs from coming out from between the upper rear facing surface 22 and the lower rear facing surface 37.

(8-2) In relation to (8-1), in the eighth embodiment, the upper rear trap rib 105 and the trap reinforcement portion 127 are provided on the front side, that is, on the inner side in the radial direction, than the upper rear welding rib 23 and the lower rear welding rib 38.

Therefore, the burr can be more strongly restricted from entering the duct body portion 11 and being carried to the vehicle compartment by the air A1 flowing through the flow path 12.

### Modifications

The above embodiments may be modified and implemented as follows. In addition, the above-described embodiments and the following modifications may be combined with each other and implemented without technical contradiction.

In each of the embodiments including the first embodiment, the portion from which the steering column SC is suspended in front of the duct body portion 11 may be provided on only one of the upper front support portion 77 and the lower front support portion 82.

Each of the third to fifth embodiments may be applied to the vehicle beam 10 according to the first embodiment instead of the second embodiment.

Both the linear welding rib 92 (FIG. 14) in the fourth embodiment and the annular welding rib 93 (FIG. 15) in the fifth embodiment may be formed on the inner circumferential surface 91b of the first tube portion 91. Further, both the linear welding rib 102 (FIG. 14) in the fourth preferred embodiment and the annular welding rib 103 (FIG. 15) in the fifth preferred embodiment may be formed on the outer circumferential surface 101a of the second tube portion 101. The first tube portion 91 and the second tube portion 101 may be joined together by welding the linear welding ribs 92, 102 and welding the annular welding ribs 93, 103.

In the second embodiment, the duct body portion 11 may be divided into three or more duct divided bodies in the circumferential direction. In this case, each of the duct divided bodies has a duct connection portion at each of both end portions in the circumferential direction. The duct facing surface of the duct connection portion at one end portion and the duct facing surface of the duct connection portion at the other end portion face in different directions. The duct welding ribs are formed on duct facing surfaces of adjacent duct connection portions. The adjacent duct connection portions are joined to each other by welding the duct welding ribs.

In this modification, the duct body portion 11 is formed by coupling adjacent duct divided bodies to each other for all the duct divided bodies. The coupling is achieved by joining the adjacent duct connection portions together. The joining is achieved by welding the duct welding ribs of the adjacent duct connection portions.

At the time of the joining, before the welding, for all the duct divided bodies, adjacent duct divided bodies are brought close to each other, and the duct welding ribs at the adjacent duct connection portions are brought close to each other.

Here, for each of the duct divided bodies, if the duct facing surface of the duct connection portion at the one end portion and the duct facing surface of the duct connection portion at the other end portion face the same direction, the following phenomenon may occur. That is, two duct welding ribs are brought close to each other in a state where the duct welding ribs of the adjacent duct connection portions do not face each other, that is, in a state where the duct welding ribs are misaligned in a direction along the duct facing surface.

In this regard, according to the modification, for each of the duct divided bodies, the duct facing surface of the duct connection portion at the one end portion and the duct facing surface of the duct connection portion at the other end portion face in different directions.

Therefore, when the adjacent duct divided bodies approach each other and the duct welding ribs of adjacent duct connection portions approach each other before the welding, the duct welding rib of the duct connection portion at the one end portion and the duct welding rib of the duct connection portion adjacent thereto come into contact with each other. By this contact, the adjacent duct divided bodies are positioned in the direction in which the duct facing surfaces of the duct connection portions face each other. Accordingly, for the adjacent duct divided bodies, the duct welding rib of the duct connection portion at the other end portion and the duct welding rib of the duct connection portion adjacent thereto are positioned in the above-described direction. With this positioning, the two duct welding ribs can be brought close to each other and welded together in a state where the duct welding rib of the duct connection portion at the other end portion and the duct welding rib of the duct connection portion adjacent thereto are made to face each other. Then, welding in the positioned state is performed on all the duct divided bodies.

In the same manner as described above, when the adjacent duct divided bodies approach each other and the duct welding ribs of adjacent duct connection portions approach each other before the welding, the duct welding rib of the duct connection portion at the other end portion and the duct welding rib of the duct connection portion adjacent thereto come into contact with each other. By this contact, the adjacent duct divided bodies are positioned in the direction in which the duct facing surfaces of the duct connection portions face each other. Accordingly, for the adjacent duct divided bodies, the duct welding rib of the duct connection portion at the one end portion and the duct welding rib of the duct connection portion adjacent thereto are positioned in the above-described direction. With this positioning, the two duct welding ribs can be brought close to each other and welded together in a state where the duct welding rib of the duct connection portion at the one end portion and the duct welding rib of the duct connection portion adjacent thereto are made to face each other. Then, welding in the positioned state is performed on all the duct divided bodies.

When the duct body portion 11 is divided into two duct divided bodies in the circumferential direction, the duct body portion 11 may be divided in the front-rear direction. In this case, the duct body portion 11 is divided into a front duct divided body forming a front half and a rear duct divided body adjacent to the rear side of the front duct divided body and forming a rear half of the duct body portion 11.

The duct body portion 11 may have a cross-sectional shape other than a circle, for example, a rectangular cross-sectional shape.

When the duct body portion 11 is divided into two duct divided bodies in the circumferential direction, one of the duct divided bodies may be formed in a flat plate shape.

The other duct divided body may have a semicircular cross-sectional shape, similarly to the first embodiment. In this case, the duct body portion 11 has a D-shaped cross-sectional shape. The other duct divided body may have a U-shaped cross-sectional shape. In this case, the duct body portion 11 has a rectangular cross-sectional shape.

The intake duct portion 51 may be divided into three or more intake duct divided bodies in the circumferential direction of the duct body portion 11.

The outlet duct portion 65 may be divided into three or more outlet duct divided bodies in the circumferential direction of the duct body portion 11.

The number of welding ribs of the same type may be modified to one or three or more. The welding ribs include the duct welding ribs, that is, the upper front welding rib 18, the upper rear welding rib 23, the upper end welding rib, the lower front welding rib 33, the lower rear welding rib 38, and the lower end welding rib 42. The welding ribs include the upper intake welding rib, the lower intake welding rib 61, the upper outlet welding rib, the lower outlet welding rib 75, the first auxiliary welding rib 89, and the second auxiliary welding rib 98.

In a case where the adjacent connection portions are joined to each other by welding, the welding ribs may be formed on both of the two facing surfaces that face each other, or may be formed on only one of the facing surfaces, as in the above-described embodiments.

The connection portions include the duct connection portions, that is, the upper front connection portion 16, the upper rear connection portion 21, the upper end connection portion 25, the lower front connection portion 31, the lower rear connection portion 36, and the lower end connection portion 39. The connection portions include the upper intake connection portion 54, the lower intake connection portion 58, the upper outlet connection portion 68, the lower outlet connection portion 73, the first auxiliary connection portion 87, and the second auxiliary connection portion 96.

The welding ribs are the same as those described in the section on the modification in the number of welding ribs of the same type.

The facing surfaces include, the duct facing surfaces, that is, the upper front facing surface 17, the upper rear facing surface 22, the lower front facing surface 32, and the lower rear facing surface 37. The facing surfaces include the first auxiliary facing surface 88 and the second auxiliary facing surface 97.

In the fourth embodiment, one of the linear welding ribs 92, 102 may be omitted.

In the fifth embodiment, one of the annular welding ribs 93, 103 may be omitted.

In the vehicle beam 10, at least one of the intake duct portion 51, the outlet duct portion 65, the upper support portion 76, and the lower support portion 81, which are portions different from the duct body portion 11, may be formed of a material different from a resin material.

In the sixth to eighth embodiments, the duct connection portion on the front side in the protruding direction of the trap rib may be provided with a recessed portion that opens in the duct facing surface, and the trap rib may extend forward in the protruding direction. The extended portion of the trap rib may enter the recessed portion while being spaced apart from the wall surface of the recessed portion.

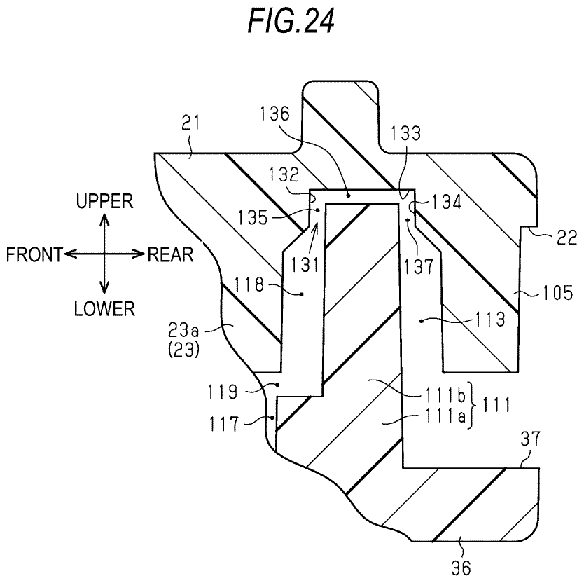

FIG. 24 shows an example in which the above modification is applied to the sixth embodiment. In this modification, a recessed portion 131 that opens at the upper rear facing surface 22 is formed in the upper rear connection portion 21. A wall surface of the recessed portion 131 is made up of a front wall surface 132 and a rear wall surface 134 which are spaced apart from each other in the front-rear direction, and a bottom wall surface 133. The trap tip portion 111b of the lower rear trap rib 111 extends upward and enters the recessed portion 131.

The front wall surface 132 and the trap tip portion 111b are spaced apart from each other in the front-rear direction via a gap 135. The bottom wall surface 133 and the trap tip portion 111b are spaced apart from each other in the upper-lower direction via a gap 136. The rear wall surface 134 and the trap tip portion 111b are spaced apart from each other in the front-rear direction via a gap 137.

In this modification, a burr moving upward through the second gap 118 passes through the gap 135, the gap 136, and the gap 137 in the recessed portion 131, and then moves to the gap 113. When the burr moves from the second gap 118 to the gap 135, the dimension in the front-rear direction decreases. The burr comes into contact with the bottom wall surface 133 when moving upward through the gap 135. The bottom wall surface 133 serves as a wall to restrict the upward movement of the burr, thereby attempting to capture the burr. A burr that is not captured by the bottom wall surface 133 changes a movement direction from upward to rearward.

The burr whose movement direction is changed comes into contact with the rear wall surface 134 when moving rearward through the gap 136. The rear wall surface 134 serves as a wall to restrict the rearward movement of the burr, thereby attempting to capture the burr. A burr that is not captured by the rear wall surface 134 changes a movement direction from rearward to downward.

In this way, the number of times that movement of the burrs is restricted increases, and accordingly, the opportunity to capture the burrs is increased. An amount of burrs captured between the upper rear facing surface 22 and the lower rear facing surface 37 increases.

The gaps 135, 136, and 137 function as spaces for trapping burrs. Therefore, it is possible to trap more burrs than in a case where the recessed portion 131 is not provided.

The trap ribs may be formed on the first auxiliary connection portion 87 and the second auxiliary connection portion 96.

The trap rib may be formed on at least one of a pair of facing surfaces of adjacent connection portions, that is, on only one or both of the facing surfaces. The connection portions include the duct connection portions, that is, the upper front connection portion 16, the upper rear connection portion 21, the upper end connection portion 25, the lower front connection portion 31, the lower rear connection portion 36, and the lower end connection portion 39. The connection portions include the upper intake connection portion 54, the lower intake connection portion 58, the upper outlet connection portion 68, the lower outlet connection portion 73, the first auxiliary connection portion 87, and the second auxiliary connection portion 96.

In the eighth embodiment, the trap rib (the upper rear trap rib 105) enters the trap reinforcement portion 127 at least by the tip end portion. Therefore, only the tip end portion of the trap rib may enter the trap reinforcement portion 127, or a larger portion of the trap rib than in the eighth embodiment may enter the trap reinforcement portion 127. For example, the entire trap rib may enter the trap reinforcement portion 127.

In the eighth embodiment, a sealing material such as a caulking material may be used as the soft material forming the trap reinforcement portion 127. In this case, the trap reinforcement portion 127 that has a cross section that is circular, rectangular, or the like and extends in the left-right direction may also be formed by applying a sealing material having high viscosity to the lower rear facing surface 37 before joining by welding. At the time of welding, when one of the upper rear connection portion 21 and the lower rear connection portion 36 is brought close to the other, a part of the upper rear trap rib 105 including the tip end portion enters the trap reinforcement portion. In this modification, the same functions and effects as those of the eighth embodiment in which the trap reinforcement portion 127 is formed of urethane or the like can be obtained.

The joining structure according to the sixth to eighth embodiments may be applied to a coupling structure between the upper end connection portion 25 and the lower end connection portion 39, a coupling structure between the upper intake connection portion 54 and the lower intake connection portion 58, and a coupling structure between the upper outlet connection portion 68 and the lower outlet connection portion 73.

Unlike the first to eighth embodiments, the beam shell portion may be formed of a member different from the duct body portion 11 on condition that the beam shell portion forms a shell of the vehicle beam 10.

What is claimed is:

1. A vehicle beam that extends in a vehicle width direction within an instrument panel of a vehicle and is attached to a vehicle body to support the instrument panel, the vehicle beam comprising:
as a framework of the vehicle beam, a tubular duct body portion having a tubular shape and a flow path for air;
a peripheral portion connected to the duct body portion; and
as a shell of the vehicle beam, a beam shell portion formed in a tubular shape and made of a resin material,
wherein the beam shell portion is divided into a plurality of beam divided bodies in a circumferential direction of the beam shell portion,
each of the beam divided bodies has a beam connection portion at a boundary with an adjacent beam divided body,
the beam divided bodies adjacent to each other are coupled by joining the beam connection portions adjacent to each other,
the beam connection portions adjacent to each other have a pair of beam facing surfaces that face each other,
at least one of the pair of beam facing surfaces is formed with a beam welding rib extending along the pair of beam facing surfaces in a direction intersecting a direction in which the pair of beam facing surfaces face each other, and
the beam connection portions adjacent to each other are joined together by welding the adjacent beam connection portions at the beam welding rib.

2. The vehicle beam according to claim 1,
wherein the duct body portion is made of a resin material,
the duct body portion is divided into a plurality of duct divided bodies in a circumferential direction of the duct body portion,
the plurality of beam divided bodies of the beam shell portion are formed by the plurality of duct divided bodies of the duct body portion,
each of the duct divided bodies has, as the beam connection portion, a duct connection portion at a boundary portion with an adjacent duct divided body,
the duct connection portions adjacent to each other have a pair of duct facing surfaces facing each other and forming the beam facing surfaces,
at least one of the pair of duct facing surfaces is formed with, as the beam welding rib, a duct welding rib extending along the pair of duct facing surfaces in a direction intersecting a facing direction in which the pair of duct facing surfaces face each other,
the duct connection portions adjacent to each other are joined together by welding at the duct welding rib, and
due to the joining of the adjacent duct connection portions, the duct divided bodies adjacent to each other are coupled, and the beam divided bodies adjacent to each other are coupled.

3. The vehicle beam according to claim 2,
wherein the duct welding rib is formed on each of the pair of duct facing surfaces of the adjacent duct connection portions,
the duct welding rib formed on one of the duct facing surfaces and the duct welding rib formed on an other one of the duct facing surfaces face each other in the facing direction,
the adjacent duct connection portions are joined together by welding a pair of the duct welding ribs that face each other in the facing direction, and
the duct divided bodies adjacent to each other are coupled due to the joining of the adjacent duct connection portions.

4. The vehicle beam according to claim 3,
wherein each of the duct divided bodies has the duct connection portion on each of both end portions of the duct body portion in the circumferential direction, and
the duct facing surface of the duct connection portion on a one end portion and the duct facing surface of the duct connection portion on an other end portion face different directions.

5. The vehicle beam according to claim 4,
wherein the duct body portion is divided into two duct divided bodies as the plurality of duct divided bodies,
the duct connection portions of each of the duct divided bodies are positioned on both sides of the flow path in a radial direction of the duct body portion, and
for each of the duct divided bodies, the duct facing surface of the duct connection portion on the one end portion faces in a direction different from and intersecting with a direction in which the duct facing surface of the duct connection portion on the other end portion faces.

6. The vehicle beam according to claim 2,
wherein the peripheral portion includes an intake duct portion that protrudes outward in a radial direction of the duct body portion from the duct body portion and takes air outside the duct body portion into the flow path,
the intake duct portion is divided into a plurality of intake duct divided bodies in the circumferential direction of the duct body portion,
each of the intake duct divided bodies is formed with an intake connection portion at a boundary with an adjacent intake duct divided body,
the intake duct divided bodies adjacent to each other are coupled by joining a pair of adjacent intake connection portions to each other,
at least one of the adjacent intake connection portions is formed with an intake welding rib that extends in a direction intersecting a direction in which the pair of intake connection portions face each other and that is connected to the duct welding rib of the duct divided body, and
the adjacent intake connection portions are joined together by welding the pair of intake connection portions at the intake welding rib.

7. The vehicle beam according to claim 2,
wherein the duct body portion is further divided into a plurality of duct body components in the vehicle width direction, and the duct body components adjacent to each other are coupled by welding.

8. The vehicle beam according to claim 7,
wherein each of the duct body components is formed with an auxiliary connection portion at a boundary with an adjacent duct body component,
the duct body components adjacent to each other are coupled by joining the adjacent auxiliary connection portions to each other,
the adjacent auxiliary connection portions have a pair of auxiliary facing surfaces that face each other in the vehicle width direction,
the auxiliary facing surface of at least one of the adjacent auxiliary connection portions is formed with an auxiliary welding rib having an annular shape and surrounding the flow path, and
the adjacent auxiliary connection portions are joined together by welding the adjacent auxiliary connection portions at the auxiliary welding rib.

9. The vehicle beam according to claim 7,
wherein in a case where one of the adjacent duct body components is defined as a first duct body component, and an other one of the adjacent duct body components is defined as a second duct body component,
the first duct body component includes a first tube portion at an end portion in the vehicle width direction, and
the second duct body component includes a second tube portion at an end portion in the vehicle width direction,
the second tube portion is inserted into the first tube portion such that the first tube portion of the first duct body component overlaps with the second tube portion of the second duct body component in a radial direction of the first tube portion and the second tube portion, and
a linear welding rib extending in the vehicle width direction is formed on at least one of an inner circumferential surface of the first tube portion or an outer circumferential surface of the second tube portion, and the first duct body component and the second duct body component are coupled by welding the first tube portion and the second tube portion at the linear welding rib.

10. The vehicle beam according to claim 7,
wherein in a case where one of the adjacent duct body components is defined as a first duct body component, and an other one of the adjacent duct body components is defined as a second duct body component,
the first duct body component includes a first tube portion at an end portion in the vehicle width direction, and
the second duct body component includes a second tube portion at an end portion in the vehicle width direction,
the second tube portion is inserted into the first tube portion such that the first tube portion of the first duct body component overlaps with the second tube portion of the second duct body component in a radial direction of the first tube portion and the second tube portion, and
an annular welding rib extending in the circumferential direction of the duct body portion is formed on at least one of an inner circumferential surface of the first tube portion or an outer circumferential surface of the second tube portion, and the first duct body component and the second duct body component are coupled by welding the first tube portion and the second tube portion at the annular welding rib.

11. The vehicle beam according to claim 2,
wherein the duct body portion and the peripheral portion are disposed above a steering column of the vehicle,
the duct body portion is divided into, as the plurality of duct divided bodies, an upper duct divided body and a lower duct divided body located below the upper duct divided body,
the peripheral portion includes:
an upper support portion connected to the upper duct divided body; and
a lower support portion connected to the lower duct divided body,
the upper support portion includes:
an upper front support portion disposed on a front side of the upper duct divided body and connected to the duct connection portion on the front side of the upper duct divided body; and
an upper rear support portion disposed on a rear side of the upper duct divided body and connected to the duct connection portion on the rear side of the upper duct divided body,
the lower support portion includes:
a lower front support portion which is connected at a rear end portion thereof to the lower duct divided body and has a portion disposed on a lower side of the upper front support portion; and
a lower rear support portion which is disposed on a rear side of the lower duct divided body and on a lower side of the upper rear support portion and is connected to the duct connection portion on the rear side of the lower duct divided body, and
at least one of the upper front support portion or the lower front support portion is provided with a portion where the steering column is suspended in front of the duct body portion, and each of the upper rear support portion and the lower rear support portion is provided with a portion where the steering column is suspended at a rear of the duct body portion.

12. The vehicle beam according to claim 2,
wherein at least one of the pair of duct facing surfaces of the adjacent duct connection portions is formed with, at a location spaced apart from the duct welding rib in a radial direction of the duct body portion, a trap rib configured to trap a burr generated during welding between the pair of duct facing surfaces, and
the trap rib extends along the pair of duct facing surfaces in a direction intersecting the facing direction.

13. The vehicle beam according to claim 12,
wherein the trap rib is formed on an inner side in the radial direction of the tubular duct body portion than the duct welding rib, the inner side being closer to the flow path for air in the radial direction of the duct body portion.

14. The vehicle beam according to claim 12,
wherein a plurality of the trap ribs are provided,
two of the plurality of trap ribs are formed on each of the pair of duct facing surfaces of the adjacent duct connection portions at locations spaced apart from each other in the radial direction of the duct body portion,
the two trap ribs protrude in opposite directions along the facing direction in a state of being adjacent to each other in the radial direction, and
when the two trap ribs are viewed from the radial direction, a portion which is a part of one of the trap ribs in the facing direction and includes a tip end portion of the one trap rib overlaps in the facing direction with a portion which is a part of an other one of the trap ribs in the facing direction and includes a tip end portion of the other one trap rib.

15. The vehicle beam according to claim 12,
wherein the trap rib protrudes from one of the pair of duct facing surfaces of the adjacent duct connection portions toward an other one of the pair of duct facing surfaces,
a trap reinforcement portion made of a material softer than the trap rib is attached to the other one duct facing surface, and
at least a tip end portion of the trap rib in a protruding direction enters the trap reinforcement portion.

16. The vehicle beam according to claim 12,
wherein the duct welding rib and the trap rib protrude in opposite directions along the facing direction in a state of being spaced apart from each other in the radial direction of the duct body portion,
the duct welding rib includes:
a welding base portion located on a base end side in a protruding direction of the duct welding rib; and
a welding tip portion adjacent to a tip end side in the protruding direction of the duct welding rib with respect to the welding base portion,
the trap rib includes:
a trap base portion located on a base end side in a protruding direction of the trap rib; and
a trap tip portion adjacent to a tip end side in the protruding direction of the trap rib with respect to the trap base portion,
the duct welding rib is formed such that a dimension of the welding tip portion in the radial direction is smaller than a dimension of the welding base portion in the radial direction,
the trap rib is formed such that a dimension of the trap tip portion in the radial direction is smaller than a dimension of the trap base portion in the radial direction, and
the trap base portion and the welding tip portion are spaced apart from each other in the radial direction via a first gap extending in the facing direction, the welding base portion and the trap tip portion are spaced apart from each other in the radial direction via a second gap extending in the facing direction, and the trap base portion and the welding base portion are spaced apart from each other in the facing direction via a communication gap that extends in the radial direction and communicates the first gap and the second gap.
